(19) United States
(12) Patent Application Publication
(10) Pub. No.: US 2011/0050727 A1
(43) Pub. Date: Mar. 3, 2011

(54) Picture/character simultaneously displaying device and head mounted display device

(75) Inventor: Hiroshi Mukawa, Kanagawa (JP)

(73) Assignee: Sony Corporation, Tokyo (JP)

(21) Appl. No.: 12/805,341

(22) Filed: Jul. 27, 2010

(30) Foreign Application Priority Data
Sep. 2, 2009 (JP) 2009-202686

(51) Int. Cl. G09G 5/00

(52) U.S. Cl. 345/636

(57) ABSTRACT

A picture/character simultaneously displaying device includes: a picture display device for displaying a picture based on picture data; and a character display device for displaying characters synchronous with the picture based on character data. The character data contains therein text data about characters synchronous with a picture to be displayed, and metadata about characters to be displayed.

### BACKGROUND OF THE INVENTION

1. Field of the Invention

The present invention relates to a picture/character simultaneously displaying device and a head mounted display device composing the same.

2. Description of the Related Art

A Rear Window Captioning System is developed in a CPB/WGBH Accessible Media Center (NCAM). This technique is such that a caption (a closed caption in a theater film) for hearing-impaired persons in a theater film is displayed on each of screens mounted to chairs of members of the audience. Specifically, as shown in FIG. 20, a mirror-reversed caption is displayed in the rear of the member of the audience, this display is reflected by a half-mirror in an audience seat, and the member of the audience views this caption display superimposed on a forward film screen. It is noted that http://ncam.wgbh.org/mopix/ can be given as an URL which discloses such a system. This technique, for example, is disclosed in a non-patent literary document of “Motion Picture Access” [retrieved on Sep. 2, 2009], Internet <URL http://ncam.wgbh.org/mopix/>.

### SUMMARY OF THE INVENTION

Now, with such a technique, the brightness of the characters in the caption is constant. Here, in the case where the luminance of the characters in the caption is set as a luminance such that the characters in the caption are easy to read even in a bright scene in a film, when the scene is dark, the screen becomes difficult to view because the characters in the film is too bright. Contrary to this, in the case where the luminance of the characters in the caption is set as such a luminance as to be easy to read the characters in the caption even in the dark scene of the film, when the scene is bright, the screen becomes difficult to view because the characters in the film is too dark. In addition, the color of the characters in the caption is constant, and thus does not change. Therefore, there is caused such a problem that the visibility of the characters in the caption is temporarily reduced depending on the color of a portion (background) of the scene of the film, in which the caption is superimposed. Even in a caption indicator which is displayed in a wing of a stage in a drama, the luminance of the characters in the caption displayed on the caption indicator is constant, and thus the same problem as that described above is caused. In addition, a development for a system which allows a member of the audience to reliably read a description for describing contents, a progress status, a background and the like of a play without moving his/her sight line so much is strongly desired in the viewing of the play or the like. Moreover, with the technique described above, it may be impossible to simultaneously display descriptions (for example, descriptions based on different languages) suitable for members of the audience, respectively.

The present invention has been made in order to solve the problems described above, and it is therefore desirable to provide a picture/character simultaneously displaying device in which a caption, and characters for a description or the like of an object or the like viewed by a member of the audience can be prevented from becoming difficult to visibly observe depending on a background of the characters, and a head mounted display device composing the same.

In order to attain the desire described above, according to an embodiment of the present invention, there is provided a picture/character simultaneously displaying device including:

(a) a picture display device for displaying a picture based on picture data; and

(b) a character display device for displaying characters synchronous with the picture based on character data, in which

the character data contains therein
(i) text data about characters synchronous with a picture to be displayed, and
(ii) metadata about characters to be displayed.

According to another embodiment of the present invention, there is provided a head mounted display device including:

(A) a glass type frame mounted to a head portion of an observer; and

(B) an image display device mounted to the glass type frame for displaying characters based on character data; in which the character data contains therein
(i) text data about characters relating to an object viewed through the image display device, and
(ii) metadata about characters to be displayed.

The head mounted display device according to the another embodiment of the present invention either may include one image display device (monocular type head mounted display device) or may include two image display devices (binocular type). In addition, the image display device either may be fixedly mounted to the eyeglass type frame or may be detachably mounted to the eyeglass type frame.

In the picture/character simultaneously displaying device of the present invention or the head mounted display device of the present invention, the character data contains therein not only the text data, but also the metadata about the characters to be displayed. Therefore, it is possible to prevent the caption, and the characters for the description or the like of the object or the like viewed by a member of the audience from becoming difficult to visually observe depending on the background of the characters. In addition, in the case of the head mounted display device of the present invention or the character display device in the picture/character simultaneously displaying device of the present invention constructed in the form of the head mounted display device, the observer (the member of the audience) can reliably read the description for describing the contents, the progress status, the background and the like of the play without moving his/her sight line so much in the viewing of the play or the like. Moreover, it is possible to readily, simultaneously display the descriptions (for example, the descriptions based on the different languages) suitable for the observers (the members of the audience), respectively.

### BRIEF DESCRIPTION OF THE DRAWINGS

FIG. 1 is a conceptual diagram, partly in block, of a picture/character simultaneously displaying device according to Embodiment 1 of the present invention;

FIG. 2 is a conceptual diagram, partly in block, of an image display device in a character display device composing the picture/character simultaneously displaying device according to Embodiment 1 of the present invention;

FIG. 3 is a perspective view schematically showing propagation of a light through a light guide plate composing the image display device in the picture/character simultaneously displaying device according to Embodiment 1 of the present invention;

FIG. 4 is a schematic view when a head mounted display device composing the character display device composing the picture/character simultaneously displaying device according to Embodiment 1 of the present invention is viewed from an upper side;

FIG. 5 is a schematic view when the head mounted display device composing the character display device composing the picture/character simultaneously displaying device according to Embodiment 1 of the present invention is laterally viewed;

FIG. 6 is a block diagram of a circuit for producing metadata in the picture/character simultaneously displaying device according to Embodiment 1 of the present invention;

FIG. 7 is a conceptual diagram of an image display device in a character display device composing a picture/character simultaneously displaying device according to Change 1 of Embodiment 1;

FIGS. 8A and 8B are respectively a conceptual diagram of an image display device in a character display device composing a picture/character simultaneously displaying device according to Change 2 of Embodiment 1, and a partially enlarged schematic cross sectional view of a reflective volume hologram diffraction gating shown in FIG. 8A;

FIG. 9 is a conceptual diagram of an image display device in a character display device composing a picture/character simultaneously displaying device according to Change 3 of Embodiment 1;

FIGS. 10A and 10B are respectively a perspective view schematically showing propagation of a light through a light guide plate composing an image display device in a picture/character simultaneously displaying device according to Change 4 of Embodiment 1, and a conceptual diagram showing a disposition state of the light guide plate and the like shown in FIG. 10A;

FIG. 11 is a schematic view of a head mounted display device when the head mounted display device composing a character display device in Change 4 is laterally viewed;

FIGS. 12A and 12B are respectively a perspective view schematically showing propagation of a light through a light guide plate composing an image display device in a picture/character simultaneously displaying device according to Change 5 of Embodiment 1, and a conceptual diagram showing a disposition state of the light guide plate and the like shown in FIG. 12A;

FIG. 13 is a conceptual view showing a disposition state of a light guide plate and the like composing an image display device in a character display device in a picture/character simultaneously displaying device according to Change 6 of Embodiment 1 of the present invention;

FIG. 14 is a conceptual view showing a disposition state of a light guide plate and the like composing an image display device in a character display device in a picture/character simultaneously displaying device according to Change 7 of Embodiment 1 of the present invention;

FIGS. 15A and 15B are respectively views schematically showing a situation in which even when a head of an observer to which the character display device composing a picture/character simultaneously displaying device according to Change 6 of Embodiment 1 of the present invention is mounted is inclined, the observer can observe characters horizontally held;

FIG. 16 is a conceptual view showing a disposition state of a light guide plate and the like composing an image display device in a character display device in a picture/character simultaneously displaying device according to Change 8 of Embodiment 1 of the present invention;

FIG. 17 is a conceptual view showing a disposition state of a light guide plate and the like composing an image display device in a character display device in a picture/character simultaneously displaying device according to Change 9 of Embodiment 1 of the present invention;

FIG. 18 is a schematic view when a head mounted display device composing a character display device in Change 10 of Embodiment 1 is laterally viewed;

FIG. 19 is a schematic view when a head mounted display device composing a character display device in Change 11 of Embodiment 1 is laterally viewed;

FIG. 20 is a conceptual view schematically showing a picture/character simultaneously displaying device according to Change 12 of Embodiment 1 of the present invention, and a picture/character simultaneously displaying device according to the related art;

FIG. 21 is a conceptual view of a picture/character simultaneously displaying device according to Change 13 of Embodiment 1 of the present invention;

FIG. 22 is a conceptual view, partly in block, in a state in which a head mounted display device according to Embodiment 2 of the present invention is used; and

FIG. 23 is a schematic view when a form of a head mounted display device composing the picture/character simultaneously displaying device according to Embodiment 1 of the present invention is laterally viewed.

### DETAILED DESCRIPTION OF THE PREFERRED EMBODIMENTS

The preferred embodiments of the present invention will be described in detail hereinafter with reference to the accompanying drawings. The present invention is by no means limited to the preferred embodiments, and the various numerical values and materials stated in the embodiments are merely exemplified. It is noted that the description will be given below in accordance with the following order.

1. General Description of Picture/character simultaneously displaying device and Head Mounted Display Device of the Present Invention

2. Embodiment 1 (Picture/character simultaneously displaying device of the Present Invention)

3. Change 1 (Change of Embodiment 1)

4. Change 2 (Change of Embodiment 1)

5. Change 3 (Change of Embodiment 1)

6. Change 4 (Change of Embodiment 1)

7. Change 5 (Change of Embodiment 1)

8. Change 6 (Change of Embodiment 1)

9. Change 7 (Change of Embodiment 1)

10. Change 8 (Change of Embodiment 1)

11. Change 9 (Change of Embodiment 1)

12. Change 10 (Change of Embodiment 1)

13. Change 11 (Change of Embodiment 1)

14. Change 12 (Change of Embodiment 1)

15. Change 13 (Change of Embodiment 1)

16. Embodiment 2 (Head Mounted Display Device of the Present Invention and Others)

### General Description of Picture/Character Simultaneously Displaying Device and Head Mounted Display Device of the Present Invention

In the picture/character simultaneously displaying device of the present invention, metadata can be obtained in the form of luminance data or chromaticity data about characters to be displayed (for example, projected), or the luminance data and chromaticity data about the characters to be displayed. In this case, the luminance data composing the metadata can be obtained in the form of the luminance data corresponding to an average luminance in either all area or a predetermined area of a picture with which characters are synchronized. Also, the chromaticity data composing the metadata can be obtained in the form of the chromaticity data corresponding to an average chromaticity in either all the area or the predetermined area of the picture with which characters are synchronized. In addition, in the head mounted display device of the present invention, metadata can be obtained in the form of the luminance data or chromaticity data about the characters to be displayed (for example, projected), or the luminance data and chromaticity data about the characters to be displayed. In this case, the luminance data composing the metadata can be obtained in the form of the luminance data corresponding to a luminance of a predetermined area containing therein an object viewed through an image display device. Also, the chromaticity data composing the metadata can be obtained in the form of the chromaticity data corresponding to a chromaticity of the predetermined area containing therein the object viewed through the image display device.

Here, when the luminance data composing the metadata is obtained in the form of the average luminance in either all the area or the predetermined area of the picture with which the characters are synchronized, or the luminance data corresponding to the luminance of the predetermined area containing therein the object viewed through the image display device, a value of the luminance data composing the metadata can be set in such a way that a value of the luminance of the characters to be displayed becomes high (that is, the characters are more brightly displayed) as a value of the average luminance in all the area of the picture with which the characters are synchronized, a value of the average luminance in the predetermined area of the picture with which the characters are synchronized, or a value of the luminance of the predetermined area containing therein the object viewed through the image display device becomes higher. In addition, when the chromaticity data composing the metadata is obtained in the form of the average chromaticity in either all the area or the predetermined area of the picture with which the characters are synchronized, or the chromaticity data corresponding to the chromaticity of the predetermined area containing therein the object viewed through the image display device, a value of the chromaticity data composing the metadata can be set in such a way that the average chromaticity in all the area of the picture with which the characters are synchronized, the average chromaticity in the predetermined area of the picture with which the characters are synchronized, or the chromaticity of the predetermined area containing therein the object viewed through the image display device, and the chromaticity of the characters to be displayed show approximately a complementary color relationship. The complementary color points to a combination of colors having a relationship of being located 180-degree turn in a color circle. That is to say, the complementary color also points to a combination of the complementary colors such as green against red, purple against yellow, or orange against blue. The complementary color also means the colors with which reduction of a saturation is caused in the case of white in the case of a light, or in the case of black in the case of an object by mixing a certain color with another color with each other at a suitable ratio. However, a complementary property of a visual effect when the complementary colors are arranged in parallel with each other, and a complementary property when the complementary colors are mixed with each other are different from each other. Thus, the complementary color is also referred to as a complementary color, a contrast color or an opposite color. However, the opposite color directly points to a color to which the complementary color is opposite, whereas a range to which the complementary color points is slightly wide. A color combination of the complementary colors has a synergetic effect that the mutual colors bring out each other, and is referred to as complementary chord.

In the picture/character simultaneously displaying device of the present invention including the various preferred forms described above, the character display device can be composed of a head mounted display device including:

(A) an eyeglass type frame mounted to a head of an observer (a member of the audience); and

(B) an image display device mounted to the eyeglass type frame for displaying the characters based on the character data. That is to say, such a character display device has the same constitution and construction as those of the head mounted display device of the present invention except for the different character data. The character display device either may include one image display device (monocular type character display device) or may include two image display devices (binocular type character display device). In addition, the image display device either may be fixedly mounted to the eyeglass type frame or may detachably mounted to the eyeglass type frame. It is noted that the character display device having such a construction is referred to as “the head mounted display type character display device” for the sake of convenience of the description in some cases.

Also, when the character display device is obtained in the form of the head mounted display type character display device, a distance between a picture displayed (for example, projected) by the picture display device, and the observer (the member of the audience), and a virtual image distance of the characters displayed by the image display device are preferably made equal to each other. In addition, in the head mounted display device of the present invention including the preferred various forms described above, there is preferably adopted a construction such that the distance between the object and the observer (the member of the audience), the virtual image distance of the characters displayed by the image display device are made equal to each other. That is to say, the characters are preferably displayed by the image display device in such a way that the observer (the member of the audience) who views the picture or the object displayed (for example, projected) by the picture display device can naturally read the characters displayed by the image display device without changing a focal point so much. In other words, as far as such a state is attained, it can be said that the distance between the picture displayed by the picture display device, and the observer (the member of the audience), and the virtual image distance of the characters displayed by the image display device are equal to each other, and also the distance between the object and the observer (the member of the audience), and the virtual image distance of the characters displayed by the image display device are equal to each other. The virtual image distance of the characters displayed by the image display device can be fixed, or for example, can be made variable on a 1 m to 1 m basis, on a 2 m to 2 m basis or the like. When the character display device or the head mounted display device of the picture/character simultaneously displaying device, is provided with an image pickup device, the distance between the picture displayed by the picture display device, and the observer (the member of the audience), and the distance between the object and the observer (the member of the audience) can be measured by the image pickup device, thereby making it possible to control the virtual image distance of the characters displayed by the image display device. It is noted that for the purpose of changing the virtual image distance of the characters displayed by the image display device, for example, a distance (optical path length) between an optical system for converting a light emitted from an image forming device which will be described next into parallel lights, and the image forming device can be changed, or a focal point distance of the optical system can be changed by using a liquid lens or the like.

In addition, in the head mounted display type character display device including the preferred forms and constitutions described above, or the head mounted display device of the present invention including the preferred forms and constitutions described above, the image display device can include:

(α) an image forming device;

(β) an optical system for converting a light emitted from the image forming device into parallel lights; and

(γ) a semi-transmissive (see-through type) optical device to which a luminous flux obtained as the parallel lights by the optical system is made incident, in which the luminous flux is guided, and from which the luminous flux is emitted. It is noted that the image display device having such a construction is referred to as “an image display device [1]” for the sake of convenience of the description. Also, the optical device can include:

(I) a light guide plate from which an incident light is emitted after being propagated through an inside of the light guide plate by total reflection;

(II) a first deflecting section for deflecting the light made incident to the light guide plate in such a way that the light made incident to the light guide plate is totally reflected inside the light guide plate; and

(III) a second deflecting section for deflecting the light propagated through the inside of the light guide plate multiple times in order to emit the light propagated through the inside of the light guide plate by the total reflection from the light guide plate. It is noted that the technical term called “total reflection” means either the internal total reflection, or the total reflection caused inside the light guide plate. This also applies to the following description. In addition, a central point of the first deflecting section corresponds to a central point of the optical device. Here, a point at which a central light beam which has been emitted from a center of the image forming device to pass through an image forming device side nodal point of the optical system is made incident to the optical device is defined as an optical device central point. In addition, an axis line which passes through the optical device central point and is parallel with a direction of an axis line of the optical device is defined as an X-axis, and an axis line which passes through the optical device central point and agrees with a normal line to the optical device is defined as a Y-axis.

Here, the first deflecting section can be constructed so as to reflect the light made incident to the light guide plate, and the second deflecting section can be constructed so as to transmit and reflect the light which has been propagated through the inside of the light guide plate multiple times. Also, in this case, the first deflecting section can be constructed so as to function as a reflecting mirror, and the second deflecting section can be constructed so as to function as a semi-transmissive mirror.

With such a construction, the first deflecting section, for example, can be composed of either a light reflecting film (a sort of mirror) which is made of a metal containing therein an alloy and which reflects the light made incident to the light guide plate, or a diffraction grating (for example, a hologram diffraction grating film) which diffracts the light made incident to the light guide plate. In addition, the second deflecting section can be composed of any one of a multilayer lamination structure in which multiple dielectric lamination films are laminated one upon another, a half-mirror, a polarization beam splitter, or a hologram diffraction grating film. Also, although the first deflecting section and the second deflecting section are disposed inside the light guide plate (incorporated in the inside of the light guide plate), the parallel lights made incident to the light guide plate is either reflected or diffracted in the first deflecting section in such a way that the parallel lights made incident to the light guide plate is totally reflected inside the light guide plate. On the other hand, the parallel lights which have been propagated through the inside of the light guide plate by the total reflection is either reflected or diffracted multiple times in the second deflecting section to be emitted in the form of the parallel lights from the light guide plate.

Or, the first deflecting section can be constructed so as to diffract the light made incident to the light guide section, and the second deflecting section can be constructed so as to diffract the light propagated through the inside of the light guide plate multiple times by the total reflection. Also, in this case, each of the first deflecting section and the second deflecting section can be constructed in the form of a diffraction grating element. Also, the diffraction grating element can be composed of either a reflective diffraction grating element or a transmissive diffraction grating element. Or, one of the diffraction grating elements can be composed of the reflective diffraction grating element, and the other diffraction grating element can be composed of the transmissive diffraction grating element. It is noted that a reflective volume hologram diffraction grating can be given as the reflective diffraction grating element. Here, the first deflecting section composed of the reflective volume hologram diffraction grating is referred to as “a first diffraction grating member” in some cases for the sake of convenience of the description, and the second deflecting section composed of the reflective volume hologram diffraction grating is referred as to “a second diffraction grating member” in some cases for the sake of convenience of the description.

When a color image is displayed on the image display device, for the purpose of causing either the first diffraction grating member or the second diffraction grating member to correspond to the diffractions and reflections of P kinds of lights (for example, P=3: three kinds of red, green and blue) having P kinds of different wavelength bands (or wavelengths), either the first diffraction grating member or the second diffraction grating member can have a construction in which P diffraction grating layers each composed of the reflective volume hologram diffracting grating are laminated one upon another. Interference fringes corresponding to one kind of wavelength band (or wavelength) are formed in each of the diffraction grating layers. Or, for the purpose of causing either the first diffraction grating member or the second diffraction grating member to correspond to the diffractions and reflections of the P kinds of lights having the P kinds of different wavelength bands (or the wavelengths), it is also possible to adopt the construction such that P kinds of interference fringes are formed in either the first diffraction grating member or second diffraction grating member composed of one diffraction grating layer. Or, a field angle, for example, is divided equally, among three, and either the first diffraction grating member or the second diffraction grating member can have a construction such that diffraction grating layers corresponding to the three equal field angles thus obtained are laminated one upon another. Also, by adopting any of those constructions, it is possible to realize an increase of a diffraction efficiency, an increase of a diffraction reception angle, and optimization of the diffraction angle when the lights having the respective wavelength bands (or respective wavelengths) are diffracted and reflected either in the first diffraction grating member or in the second diffraction grating member.

A photopolymer material can be given as a material composing each of the first diffraction grating member and the second diffraction grating member. The constituent material and basic structure of each of the first diffraction grating member and the second diffraction grating member composed of the reflective volume hologram diffraction grating can be made the same as those of the existing reflective volume hologram diffraction grating. The reflective volume hologram diffraction grating means a hologram diffraction grating for diffracting and reflecting only a +1-order diffracted light. Although in the diffraction grating member, the interference fringes are formed from the inside thereof to the surface thereof, a method of forming such interference fringes themselves can be made the same as the existing forming method. Specifically, for example, an object light is radiated from a first predetermined direction on one side to a member (for example, a photopolymer material) composing the diffraction grating member, and at the same time, a reference light is radiated from a second predetermined direction on the other side to a member composing the diffraction grating member. In this case, the interference fringes formed by the interference between the object light and the reference light can be recorded inside the member composing the diffraction grating member. The first predetermined direction, the second predetermined direction, and the wavelengths of the object light and the reference light are suitably selected, whereby it is possible to obtain a desired pitch of the interference fringes in the surface of the diffraction grating member, and a desired slant angle of the interference fringes. The slant angle of the interference fringes means an angle between the surface of the diffraction grating member (or the diffraction grating layer), and the interference fringes. When each of the first diffraction grating and the second diffraction grating is structured in the form of the lamination structure of the P diffraction grating layers each composed of the reflective volume hologram diffraction grating, all it takes is that after the P diffraction grating layers are individually formed, the P diffraction grating layers are laminated (bonded) one upon another by using an ultraviolet cure adhesive. In addition, all it takes is also that after one diffraction grating layer is made of the photopolymer material having an adherence property, the photopolymer materials each having the adherence property are stuck one after another to form the diffraction grating layers, thereby forming the P diffraction grating layers.

Or, the optical device can be composed of a semi-transmissive mirror to which a light emitted from the image forming device is made incident and is emitted toward a pupil of an eye of the observer. It is noted that a structure may also be adopted such that the light emitted from the image forming device is propagated through the air to be made incident to the semi-transmissive mirror. Or, for example, a structure may also be adopted such that the light emitted from the image forming device is propagated through the inside of a transparent member such as a glass plate or a plastic plate (specifically, a member made of the same material as that composing the light guide plate which will be described later) to be made incident to the semi-transmissive mirror. It is noted that the semi-transmissive mirror may be mounted to the image forming device through this transparent member, or the semi-transmissive mirror may also be mounted to the image forming device through a member different from this transparent member.

In the image display device [1] including any of the various preferred forms and constructions described above, the image forming device can have a form having a plurality of pixels disposed in a two-dimensional matrix. It is noted that the image forming device having such a construction is referred to as “an image forming device [1]” for the sake of convenience of the description.

An image forming device composed of a reflective spatial light modulator and a light source, an image forming device composed of a transmissive spatial light modulator and a light source, or an image forming device composed of a light emitting element such as an organic Electro Luminescence (EL), an inorganic EL or a Light Emitting Diode (LED), for example, can be given as the image forming device [1]. In particular, the image forming device [1] is preferably constructed in the form of the image forming device composed of the reflective spatial light modulator and the light source. A light valve, a transmissive or reflective liquid crystal display device such as a Liquid Crystal On Silicon (LCOS), or a digital Micro-Mirror Device (DMD) can be given as the spatial light modulator. Also, a light emitting element can be given as a light source. In addition, the reflective spatial light modulator can be composed of a liquid crystal display device, and a polarization beam splitter for reflecting a part of a light emitted from a light source to guide the reflected light to the liquid crystal display device, and transmitting a part of a light reflected by the liquid crystal display device to guide the reflected light to an optical system. A red light emitting element, a green light emitting element, a blue light emitting element, or a white light emitting element can be given as the light emitting element composing the light source. Or, a red light, a green light, and a blue light which are emitted from the red light emitting element, the green light emitting element, and the blue light emitting element, respectively, may be mixed with one another by using a light pipe, and the luminance may be uniformized, thereby obtaining the white light. A semiconductor laser element, a solid-state laser or an LED, for example, can be exemplified as the light emitting element. The number of pixels can be determined in accordance with a specification required for the image display device. Thus, 320×240, 432×240, 640×480, 1,024×768, 1,920×1,080, or the like can be exemplified as a concrete value of the number of pixels.

Or, in the image display device [1] including the preferred forms and constructions described above, the image forming device can have a form including a light source, and a scanning section for scanning parallel lights emitted from the light source. It is noted that the image display device having such a construction is referred to as “an image forming device [2]” for the sake of convenience of the description.

Alight emitting element can be given as the light source in the image forming device [2]. Specifically, the red light emitting element, the green light emitting element, the blue light emitting element, the white light emitting element or the like can be given as the light source in the image forming device [2]. Or, the red light, the green light, and the blue light which are emitted from the red light emitting element, the green light emitting element, and the blue light emitting element, respectively, may be mixed with one another by using the light pipe, and the luminance may be uniformized, thereby obtaining the white light. The semiconductor laser element, the solid-state laser or the LED, for example, can be exemplified as the light emitting element. The number of pixels (virtual pixels) in the image forming device [2] can be also determined in accordance with the specification required for the image display device. Thus, 320×240, 432×240, 640×480, 1,024×768, 1,920×1,080, or the like can be exemplified as a concrete value of the number of pixels (virtual pixels). In addition, when the color image is displayed and thus the light source is composed of the red light emitting element, the green light emitting element, and the blue light emitting element, for example, the color composition is preferably carried out by using a cross prism. A Micro Electro Mechanical Systems (MEMS) having a micro-mirror which can be rotated in a two-dimensional direction or a galvano-mirror, for example, can be given as the scanning section. In this case, the MEMS or the galvano-mirror carries out horizontal scanning and vertical scanning for the light emitted from the light source.

Either in the image forming device [1] or the image forming device [2], a plurality of parallel lights into which an emitted light is converted by an optical system (which is an optical system for converting an emitted light into parallel lights, and is referred to as “a parallel light emission optical system” in some cases: Specifically, a collimate optical system or a relay lens) are made incident to the light guide plate. However, a requirement that the light is converted into the parallel lights is based on the fact that light wavefront information when the parallel lights are made incident to the light guide plate needs to be also preserved after having been emitted from the light guide plate through both the first deflecting section and the second deflecting section. It is noted that for the purpose of producing a plurality of parallel lights, specifically, for example, a light emitting portion of the image forming device, for example, can be located in a place (position) of a focal point in a parallel light emission optical system. The parallel light emission optical system has a function of converting positional information about the pixels into angular information in the optical system of the optical device. An optical system which is composed of a convex lens, a concave lens, a free-form surface prism, or a hologram lens, or is obtained by a combination thereof, and which has entirely a positive optical power, for example, can be exemplified as the parallel light emission optical system. A light blocking member having an opening portion formed therein may be disposed between the parallel light emission optical system and the light guide plate so as to prevent an undesired light from being emitted from the parallel light emission optical system to be made incident to the light guide plate.

The light guide plate has two parallel surfaces (first surface and second surface) each extending in parallel with the axis line (X-axis) of the light guide plate. When a surface of the light guide plate to which the light is made incident is taken to be a light guide plate incidence surface, and a surface of the light guide plate from which the light is emitted is taken to be a light guide plate emission surface, each of the light guide plate incidence surface and the light guide plate emission surface may be composed of the first surface, or the light guide plate incidence surface may be composed of the first surface, and the light guide plate emission surface may be composed of the second surface. A glass including an optical glass such as a quartz glass or BK7, or a plastic material (such as a PMMA, a polycarbonate resin, an acrylic resin, an amorphous polypropylene system resin or a styrene system resin including an AS resin) can be given as the material composing the light guide plate. The shape of the light guide plate is by no means limited to a flat plate, and thus may have a curved shape.

Or, in the head mounted display type character display device including the preferred forms and constructions described above, or in the head mounted display device of the present invention including the preferred forms and constructions described above, an image display device composed of a transmissive spatial light modulator and a light source, specifically, a transmissive liquid crystal display device, for example, can be given as an image display device. It is noted that the image display device having such a construction is referred to as “an image display device [2]” for the sake of convenience of the description. The number of pixels can be determined in accordance with a specification required for the image display device. Thus, 320×240, 432×240, 640×480, 1,024×768, 1,920×1,080, or the like can be exemplified as a concrete value of the number of pixels.

In addition, in the case where the character display device is constructed in the form of the head mounted display type character display device, or in the head mounted display device of the present invention, an eyeglass type frame can be composed of a front portion disposed in front of the observer, and two temple portions pivotably mounted to both ends of the front portion through hinges, respectively. It is noted that a modern portion is mounted to each of head portions of the temple portions. The image display device is mounted to the frame. Specifically, in the case of the image display device [1], for example, the image forming device can be mounted to the temple portion, and in the case of the image display device [2], the image display device can be mounted either to the temple portion or to the front portion. In addition, it is possible to adopt a construction such that a nose pad is mounted. That is to say, when the entire head mounted display device is viewed, an assembly of the frame and the nose pad has the same construction as that of the normal eyeglasses. It is noted that a rim portion may be provided or may not be provided. A material composing the frame can be made the same as that, composing normal eyeglasses, such as a metal, an alloy, a plastic or a combination thereof. The nose pad can have the well-known constitution and construction.

It is possible to adopt a form such that an image pickup device is mounted to a central portion of the front portion. Specifically, the image pickup device, for example, is composed of a solid-state image pickup element composed of either a CCD or a CMOS sensor, and a lens. Wirings drawn from the image pickup device, for example, can be connected to one of the image display devices (or one of the image forming devices), and moreover can be included in wirings extending from the image display device (or the image forming device).

In the case where the character display device is constructed in the form of the head mounted display type character display device, or in the head mounted display device of the present invention, the wirings (such as a signal line and a power source line) drawn from the one or two image display devices (or one or two image forming devices) preferably extend from the head portion of the modern portion to the outside through the inside of the temple portion and the modern portion to be connected to a controller (control circuit) from a viewpoint of a design or easiness of the mounting. In addition, it is also possible to adopt a construction such that each of the image display devices (or each of the image forming devices) includes a headphone portion, and wirings for the headphone portion drawn from each of the image display devices (or each of the image forming devices) extend from the head portion of the modern portion to the headphone portion through the insides of the temple portion and the modern portion. An inner ear type headphone portion or a canal type headphone portion, for example, can be given as the headphone portion. More specifically, a constitution is preferably adopted such that the wiring for the headphone portion extends from the head portion of the modern portion to the headphone portion so as to be disposed around the back side of an ear auricle (auditory capsule).

In addition, in the picture/character simultaneously displaying device of the present invention or the head mounted display device of the present invention having the various forms and constructions described above, it is possible to adopt a form such that the character data is sent either to the character display device or to the image display device in a radio style. The character data, for example, is received by the controller described above, and processing for character display is executed in the controller described above. The controller can be configured in the form of the well-known circuit.

Or, in the picture/character simultaneously displaying device of the present invention, the character display device can also includes a character projector, and a character display section. In this case, the character projector projects characters based on the character data, and the character display section displays the characters projected by the character projector. It is noted that the character display device having such a construction is referred to as “a projection type character display device” for the sake of convenience of the description. Here, any character projector (such as a projection device or a projector) can be adopted as the character projector as long as it can project the characters based on the character data. Also, any character display section (such as a semi-transparent or opaque plastic plate, a half-mirror or a screen) can be adopted as the character display section as long as it can display the characters projected by the character projector. It is possible to adopt a form such that the character display section is allocated to each and everyone of the observer (the member of the audience). Or, it is also possible to adopt a construction such that the character display section is disposed in the vicinity of a screen composing the image display device, or a part of the screen is substituted for the character display section, thereby allowing a plurality of observers (the members of the audience) to view the caption.

In the picture/character simultaneously displaying device of the present invention, a combination of the projection device and the screen which are used in a theater, a show house or the like can be given as the image display device. The picture data may be either digital data or analog data recorded either in a film or in a video tape, and thus is suitably determined depending on the construction of the image display device used, and a system. A picture is projected from the projection device based on the picture data to be displayed on the screen. The character display device displays the characters synchronous with the picture. Specifically, for example, the character data is sent to the character display device either by a manipulation made by an operator, or under the control made by a computer or the like either based on a predetermined schedule, allocation of time or the like, or in accordance with a progress status of the film or the like, and thus the characters are displayed by the character display device. That is to say, all it takes is that the characters of the caption are displayed synchronously with the picture, or the description relating to the picture or the closed caption is displayed synchronously with the picture.

In the picture/character simultaneously displaying device of the present invention, the text data is digitized data which is used in order to display the characters synchronous with the picture to be displayed by the character display device, and thus is previously produced before display of the picture. The metadata about the characters to be displayed may be previously produced either by an operator, or based on the processing executed by the computer or the like. Or, the picture data about the picture to be displayed may be previously read out by the computer or the like in a phase of display (projection) of the picture, the picture data may be then analyzed, and the metadata may be produced in real time in accordance with the analysis results (such as the average luminance in either all the area or the predetermined area of the picture with which the characters are synchronized, and the average chromaticity in either all the area or the predetermined area of the picture with which the characters are synchronized). The area of the picture becoming the background of the characters displayed, for example, can be given as the predetermined area of the picture with which the characters are synchronized. A format of the character data can be suitably selected depending on the picture/character simultaneously displaying device and the system which are used.

The head mounted display device of the present invention, for example, can be used for the display of the various descriptions or the like relating to an object (physical object) in a play, a Kabuki, a No play, a Kyogen play, an opera, a concert, a ballet, various dramas, an amusement park, a gallery, a tourist spot, a resort, tourist information, and the like; the display of the various descriptions relating to a phase of an operation, manipulation, maintenance, a disassembly and the like of an object (physical object) such as any of the various devices; the display of the various descriptions relating to an object (physical object) such as a person or an article; and the display of the closed caption. In the case of the play, the Kabuki, the No play, the Kyogen play, the opera, the concert, the ballet, the various dramas, the amusement part, the gallery, the tourist spot, the resort, the tourist information, and the like, the characters relating to the object can be displayed at a suitable timing by the image display device. Specifically, for example, the character data is sent to the image display device either by the manipulation made by the operator, or under the control made by the computer or the like either based on the predetermined schedule, the allocation of time or the like, or in accordance with the progress status of the play or the like, and thus the characters are displayed by the image display device. In addition, when the various descriptions relating to the various devices, or the object (physical object) such as the person or the article are displayed, the image pickup device is disposed in the head mounted display device, images of the various devices, or the object (physical object) such as the person or the article are captured by using the image pickup device, and the image-captured contents are analyzed by the image display device. As a result, the various descriptions relating to the various devices, or the object (physical object) such as the person or the article which are previously produced can be displayed by the image display device.

In the head mounted display device of the present invention, the text data is the digitized data which is used in order to display the characters relating to the object viewed through the image display device by the image display device, and is previously produced in the manner described above. The metadata about the characters to be displayed may be previously produced. Or, the images of the various devices or the object (physical object) such as the person or the article may be captured by using the image pickup device, the image-captured contents are analyzed by the image display device, and the metadata may be produced in real time by the image display device in accordance with the analysis results (the luminance data corresponding to the luminance of the predetermined area containing the object viewed through the image display device, and the chromaticity data). A format of the character data can be suitably selected depending on the head mounted display device and the system which are used.

In the picture/character simultaneously displaying device of the present invention or the head mounted display device of the present invention including the preferred forms and constructions described above (hereinafter they are collectively, simply referred as to “the present invention” in some cases), when the metadata is the luminance data about the characters to be displayed, the luminance (brightness) of the characters displayed can be controlled. On the other hand, when the metadata is the chromaticity data about the characters to be displayed, the chromaticity (color) of the characters displayed can be controlled. Or, when the metadata is both the luminance data and the chromaticity data about the characters to be displayed, both the luminance data and chromaticity (brightness and color) of the characters displayed can be controlled. It is noted that symbols, codes, marks, emblems, designs and the like may be displayed in addition to the characters.

In the image display device [1], it is possible to adopt a construction such that a central light beam intersects at an angle θ other than 0° with the XY-plane. As a result, a limit to a mounting angle of the image display device when the image display device is mounted to a mounting portion of the eyeglass type frame becomes less, and thus it is possible to obtain the high degree of freedom of the design. Also, in this case, adoption of a form such that the central light beam is contained in the YZ-plane is preferable from a viewpoint of easiness of handling, setting and mounting of the image display device. In addition, it is possible to adopt a construction such that an optical axis of the optical system is contained in the YZ-plane, and intersects at an angle other than 0° with the XY-plane. Or, it is also possible to adopt a construction such that the optical axis of the optical system is parallel with each of the YZ-plane and the XY-plane, and passes through a position deviating from the center of the image forming device. In addition, when the XY-plane is assumed to agree with a horizontal plane, it is possible to adopt a construction such that the angle, θ, at which the central light beam intersects with the XY-plane is an angle of elevation. That is to say, the central light beam is directed from a lower side of the XY-plane toward the XY-plane to collide with the XY-plane. Also, in this case, the XY-plane preferably intersects with a vertical plane at an angle other than 0°, and moreover preferably intersects with the vertical plane at the angle θ. It is noted that although not limited, an angle of 5° can be given as a maximum value of the angle θ. Here, the horizontal plane means a plane in which a sight line (“a horizontal sight line of an observer”) when the observer views the object (such as the horizontal direction, an infinite distance object, a horizon, or a horizontal line) located in the horizontal direction is contained, and two pupils of the eyes of the observer horizontally located is also contained. In addition, the virtual plane is a plane vertical to the horizontal plane. Or, it is possible to adopt a form such that when the observer views the object (such as the horizontal direction, the infinite distance object, the horizon, or the horizontal line) located in the horizontal direction, the central light beam which has been emitted from the optical device to be made incident to the pupils of the eyes of the observer forms an angle of depression. An angle of 5 to 45°, for example, can be exemplified as the angle of depression with respect to the horizontal plane.

In the image display device [1], the image display device further includes a supporting member for pivotally supporting at least the image forming device with respect to the optical device. An assembly of at least the image forming device and the supporting member has the center of gravity in a position deviating from a pivotal movement axis of the supporting member, and pivots at least the image forming device with respect to the optical device by the gravity, thereby making it possible to horizontally hold the image forming device. It is noted that there is no relative motion between the optical device and the eyeglass type frame. That is to say, the optical device is placed stationarily with respect to the eyeglass type frame. In addition, in the image display device [2], the image display device is further pivotably mounted to the frame by the supporting member. An assembly of the image display device and the supporting member has the center of gravity in a position deviating from a pivotal movement axis of the supporting member, and pivots the image display device with respect to the eyeglass type frame by the gravity, thereby making it possible to horizontally hold the image display device.

By adopting those constructions, with the simple constitutions and constructions, even when the head of the observer (the member of the audience) to which the head mounted display device is mounted is inclined, the observer (the member of the audience) can observe the characters (image) which are horizontally held. In addition, an increase in weight, an increase in manufacture cost, and an increase in power consumption are all not caused. It is unnecessary to rotate the displayed image by executing the image processing. The image display device (image forming device) having a large display area is unnecessary. Also, it is unnecessary to increase the resolution of the image display device (image forming device).

Here, in the image display device [1], it is possible to adopt a construction such that the image display device includes a supporting member for pivotably supporting the image forming devices with respect to each of the optical device and the optical system. Also, with such a construction, it is possible to adopt a form such that the supporting member includes a first cylindrical member, a second cylindrical member, and a pivoting member disposed between the first cylindrical member and the second cylindrical member for relatively pivoting the first cylindrical member and the second cylindrical member. In this case, the image forming device is disposed within the first cylindrical member, the optical system is disposed within the second cylindrical member, and the optical device is mounted to the second cylindrical member. It is noted that with regard to the disposition of the image forming device within the first cylindrical member, the image forming device can be mounted to an inner surface of the first cylindrical member by a suitable mounting section or method. In addition, with regard to the disposition of the optical system within the second cylindrical member, the optical system can be mounted to the inner surface of the second cylindrical member by a suitable mounting section or method. In addition, with regard to the mounting of the second cylindrical member to the optical device, the second cylindrical member can be mounted to the optical device by a suitable mounting section or method. The supporting member, more preferably, the second cylindrical member can be mounted to the eyeglass type frame. However, a suitable mounting section or method can be used for such mounting as well. Thus, the supporting member, more specifically, the second cylindrical member can be fixed to the eyeglass type frame (more specifically, the temple portion, the front portion, or the rim portion), or can be detachably mounted to the eyeglass type frame (more specifically, the temple portion, the front portion, or the rim portion). Or, it is possible to adopt a construction such that the supporting member pivotably supports each of the image forming device and the optical system with respect to the optical device. Also, with such a construction, it is possible to adopt a form such that the supporting member includes the first cylindrical member, the second cylindrical member, and the pivoting member disposed between the first cylindrical member and the second cylindrical member for relatively pivoting the first cylindrical member and the second cylindrical member. In this case, both the image forming device and the optical system are disposed within the first cylindrical member, and the optical system is disposed within the second cylindrical member. It is noted that with regard to the disposition of the image forming device and the optical system within the first cylindrical member, each of the image forming device and the optical system can be mounted to the inner surface of the first cylindrical member by a suitable mounting section or method. In addition, with regard to the mounting of the second cylindrical member to the optical device, the second cylindrical member can be mounted to the optical system by using a suitable mounting section or method. The supporting member, more specifically, the second cylindrical member can be mounted to the eyeglass type frame. However, a suitable mounting section or method can be used for such mounting as well. Thus, the supporting member, more specifically, the second cylindrical member can be fixed to the eyeglass type frame (more specifically, the temple portion, the front portion, or the rim portion), or can be detachably mounted to the eyeglass type frame (more specifically, the temple portion, the front portion, or the rim portion).

Here, an assembly of at least the image forming device and the supporting member has the center of gravity in a position deviating (biasing) from the pivotal movement central axis of the supporting member. Specifically, however, the image forming device or the like can be supported by the supporting member in such a way that the center of gravity of the assembly is not located on the pivotal movement central axis of the supporting member. Or, the image forming device has the center of gravity in a position deviating (biasing) from the pivotal movement central axis of the supporting member. Specifically, however, the image forming device can be supported by the supporting member in such a way that the center of gravity of the image forming device is not located on the pivotal movement central axis of the supporting member. That is to say, more specifically, it is also possible to adopt a form such that the center of gravity of the supporting member agrees with the pivotal movement central axis of the supporting member, and the center of gravity of the image forming device is located away from the pivotal movement central axis of the supporting member. It is also possible to adopt a form such that the center of gravity of the image forming device agrees with the pivotal movement central axis of the supporting member, and the center of gravity of the supporting member is located away from the pivotal movement central axis of the supporting member. In addition, it is also possible to adopt a form such that the center of gravity of the entire assembly of the image forming device and the supporting member is located separately from the pivotal movement central axis of the supporting member. Also, in the image forming device [2], specifically, it is also possible to adopt a form such that the center of gravity of the supporting member agrees with the pivotal movement central axis of the supporting member, and the center of gravity of the image forming device is located away from the pivotal movement central axis of the supporting member. It is also possible to adopt a form such that the center of gravity of the image forming device agrees with the pivotal movement central axis of the supporting member, and the center of gravity of the supporting member is located away from the pivotal movement central axis of the supporting member. In addition, it is also possible to adopt a form such that the center of gravity of the entire assembly of the image forming device and the supporting member is located away from the pivotal movement central axis of the supporting member. For example, the light source is disposed on the lower side, whereby the center of gravity of the image forming device can be located away from the pivotal movement central axis of the supporting member.

In the image display device [1], each of the first cylindrical member and the second cylindrical member composing the supporting member, for example, can be made of either a plastic or a metal. A size (a diameter and a length) of each of the first cylindrical member and the second cylindrical member can be suitably determined in consideration of each of the entire sizes and the like of the image forming device, the optical system, the optical device, and the head mounted display device. The first cylindrical member and the second cylindrical member can be disposed so as to be nested inside one another through the pivoting member. The first cylindrical member and the second cylindrical member may also be disposed in such a way that the first cylindrical member covers the second cylindrical member. Or, the first cylindrical member and the second cylindrical member may also be disposed in such a way that the second cylindrical member covers the first cylindrical member. The pivoting member disposed between the first cylindrical member and the second cylindrical member, for example, can be composed of a ball bearing, a thrust bearing, a roller bearing, or a sliding bearing.

The supporting member as well in the image display device [2], for example, has also to be composed of a first cylindrical member and a second cylindrical member each made of either a plastic or a metal. A size (a diameter and a length) of each of the first cylindrical member and the second cylindrical member can be suitably determined in consideration of each of the entire sizes and the like of the image display device and the head mounted display device. The same pivoting member as that in the above case is disposed between the first cylindrical member and the second cylindrical member, whereby the first cylindrical member and the second cylindrical member can be reliably pivoted. The first cylindrical member and the second cylindrical member can be disposed so as to be nested inside one another through the pivoting member. The first cylindrical member and the second cylindrical member may be disposed in such a way that the first cylindrical member covers the second cylindrical member. Or, the first cylindrical member and the second cylindrical member may also be disposed in such a way that the second cylindrical member covers the first cylindrical member. The image display device can be disposed within the first cylindrical member. With regard to the disposition of the image display device within the first cylindrical member, the image display device can be mounted to the inner surface of the first cylindrical member by using a suitable mounting section or method. In addition, the image display device is pivotably mounted to the frame by the supporting member. Specifically, however, the second cylindrical member can be mounted to the eyeglass type frame. With regard to the mounting of the image display device to the eyeglass type frame, more specifically, the second cylindrical member can be mounted to the eyeglass type frame by using a suitable mounting section or method. Thus, the supporting member, more specifically, the second cylindrical member can be fixed to the eyeglass type frame (more specifically, the temple portion, the front portion, or the rim portion), or can be detachably mounted to the eyeglass type frame (more specifically, the temple portion, the front portion, or the rim portion).

For the purpose of suppressing an excessively relative pivotal movement between the first cylindrical member and the second cylindrical member, it is possible to adopt a construction such that the pivoting section includes a suitable pivotal movement controlling section (a sort of brake), or it is possible to adopt a construction such that a suitable pivotal movement controlling section (a sort of brake) is disposed between the first cylindrical member and the second cylindrical member.

### Embodiment 1

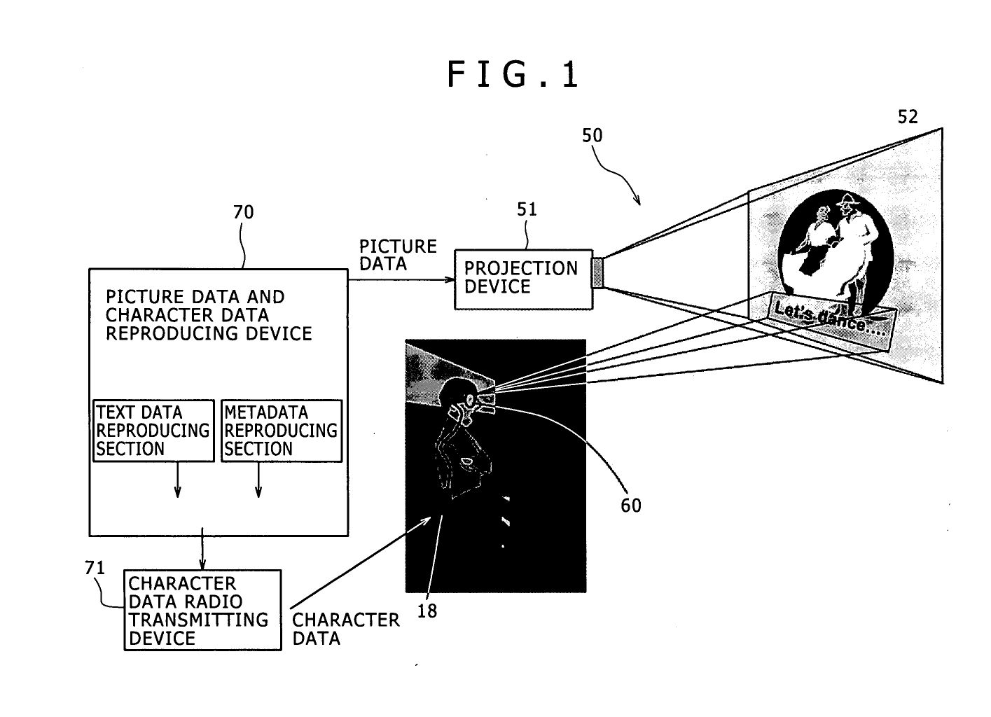

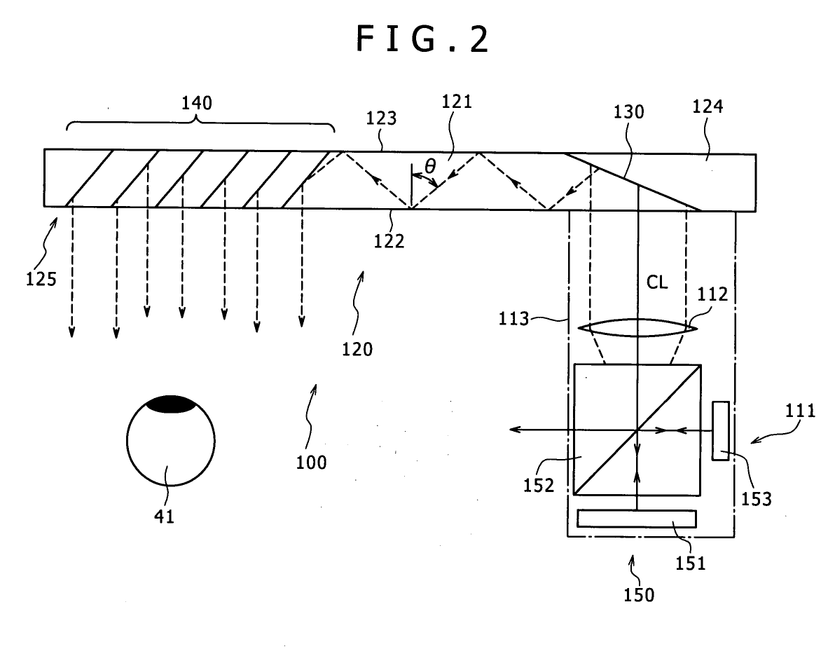

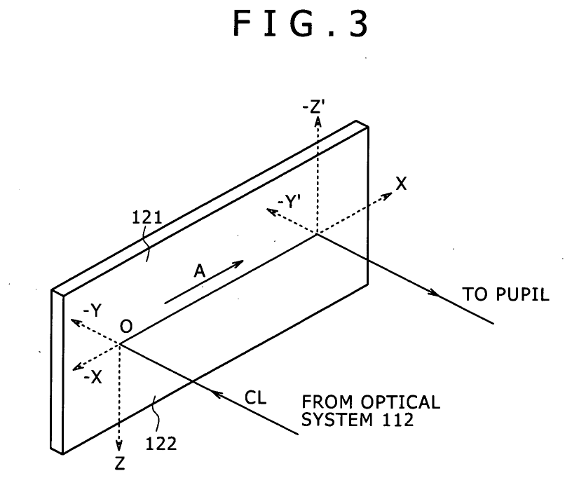

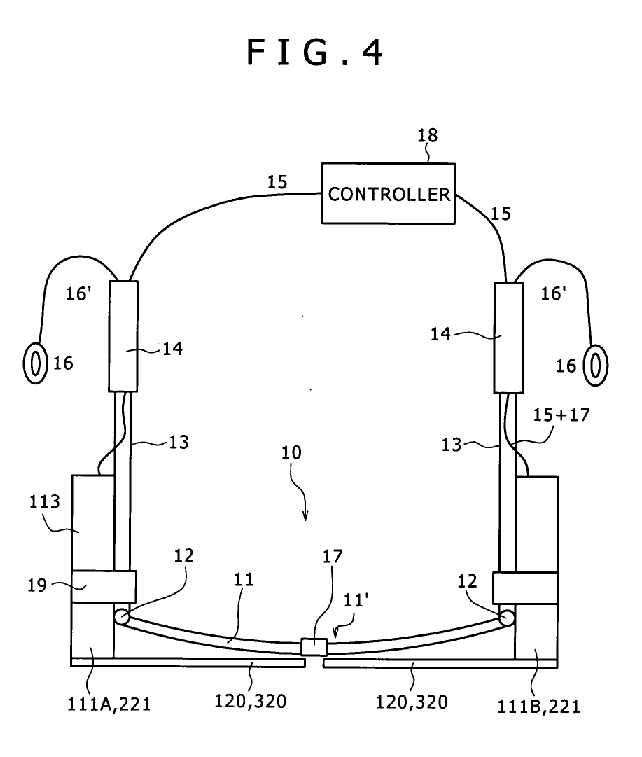

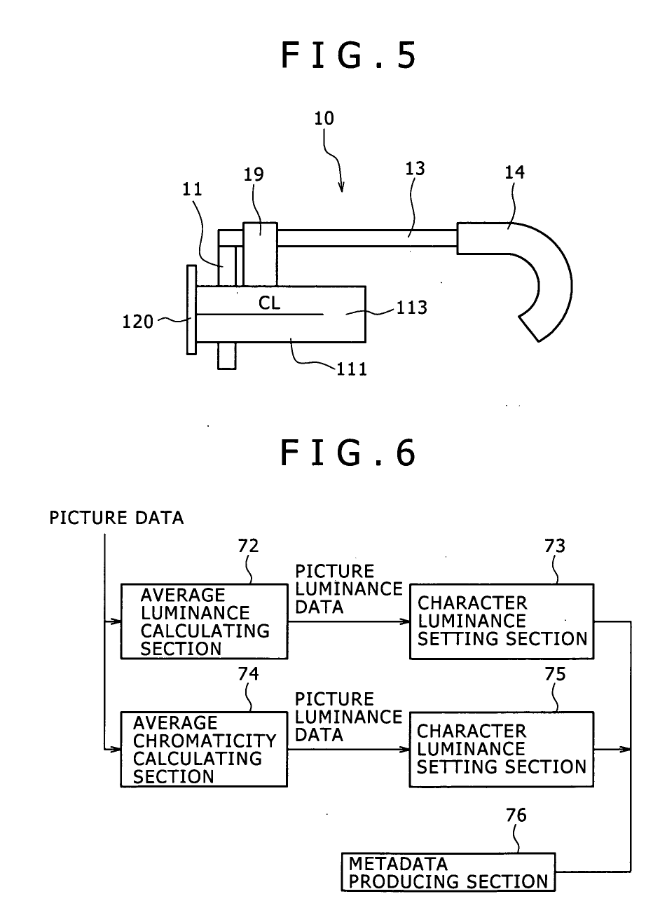

Embodiment 1 relates to the picture/character simultaneously displaying device of the present invention. FIG. 1 shows a conceptual diagram, partly in block, of the picture/character simultaneously displaying device according to Embodiment 1 of the present invention. FIG. 2 shows a conceptual diagram of an image display device in a character display device composing the picture/character simultaneously displaying device according to Embodiment 1 of the present invention. Also, FIG. 3 schematically shows propagation of a light in a light guide plate composing the image display device in the picture/character simultaneously displaying device according to Embodiment 1 of the present invention. In addition, FIG. 4 shows a schematic view when a head mounted display device composing the character display device in Embodiment 1 of the present invention is viewed from an upper side. Also, FIG. 5 shows a schematic view when the head mounted display device composing the character display device in Embodiment 1 of the present invention is laterally viewed.

The picture/character simultaneously displaying device of Embodiment 1 or any of Changes 1 to 13 of Embodiment 1 which will be described later includes:

(a) a picture display device 50 for displaying a picture based on picture data; and

(b) a character display device 60 for displaying characters synchronous with the picture based on character data.

Specifically, it is supposed that the picture display device 50 is used in the theater, the show house or the like in Embodiment 1 or any of Changes 1 to 13 of Embodiment 1 which will be described later, and is composed of a combination of a projection device 51 and a screen 52. Also, the picture data composed of digital data which is reproduced by a picture data and character data reproducing device (a picture data/character data reproducing device 70) is sent to the projection device 51, and the picture is projected based on the picture data by the projection device 51 to be displayed on the screen 52. The character display device 60 will be described later.

The character data contains therein:

(i) text data about characters synchronous with the picture to be displayed; and

(ii) metadata about the characters to be displayed.

Here, the text data is digitized data which is used in order to display the characters synchronous with the picture to be displayed by the character display device 60, and is previously produced before display of the picture. In addition, the metadata about the characters to be displayed, for example, is previously produced by an operation made by an operator. Specifically, the metadata, for example, is the luminance data and chromaticity data about the characters to be displayed (for example, projected). Also, the luminance data composing the metadata is the luminance data corresponding to an average luminance in a predetermined area of the picture with which the characters are synchronized, and the chromaticity data composing the metadata is the chromaticity data corresponding to an average chromaticity in the predetermined area of the picture with which the characters are synchronized. It is noted that the predetermined area of the picture with which the characters are synchronized can be made an area of the picture becoming the background of the displayed characters, or can be made an area corresponding to the lower third part of the screen. More specifically, the operator can determine both the luminance and chromaticity of the characters to be displayed so as to correspond to both the luminance and chromaticity of an area, becoming the background of the characters displayed, in the picture projected on the screen while he/she views such an area. Also, the operator can produce the metadata about the luminance and chromaticity of the characters to be displayed by manipulating the computer to record the metadata thus produced in the computer. It is noted that a value of the luminance data composing the metadata can be set in such a way that the value of the luminance of the characters to be displayed becomes larger (that is, the characters are more brightly displayed) as the value of the luminance of such an area becomes larger. In addition, a value of the chromaticity data composing the metadata can be set in such a way that the chromaticity of such an area, and the chromaticity of the characters to be displayed approximately show the complementary color relationship. The character data composed of the text data and the metadata is reproduced by a well-known picture data/character data reproducing device 70, and is then sent to the character display device 60 through a character data radio transmitting device 71 in a radio style. Since the metadata is produced as the luminance data about the characters to be displayed in such a manner, it is possible to control the luminance (brightness) of the characters to be displayed. Also, since the metadata is produced as the chromaticity data as well about the characters to be displayed, it is possible to control the chromaticity (color) of the characters to be displayed.

The character display device 60 displays the characters synchronous with the picture. Specifically, for example, the character data is sent to the character display device 60 under the control made by a computer (not shown) provided in the picture data/character data reproducing device 70 either based on a predetermined schedule, allocation of time and the like, or in accordance with a progress status of a film or the like, and thus the characters are displayed by the character display device 60. That is to say, the characters in the caption are displayed synchronously with the picture, or the descriptions about the picture, and the closed caption are displayed synchronously with the picture.

In Embodiment 1 or any of Changes 1 to 11 of Embodiment 1, the character display device 60 is composed of a head mounted display type character display device. That is to say, the character display device 60 is composed of the head mounted display device including:

(A) an eyeglass type frame 10 mounted to a head of an observer (a member of the audience); and

(B) an image display device 100, 200, 300, 400 mounted to the eyeglass type frame 10 for displaying the characters based on the character data. The image display device 100, 200, 300, 400 either may be fixedly mounted to the eyeglass type frame 10, or may be detachably mounted to the eyeglass type frame 10. It is noted that although the character display device 60 of Embodiment 1 or any of Changes 1 to 11 of Embodiment 1 which will be described later is concretely constructed in the form of a binocular type character display device including two image display devices, it may also be mounted in the form of a monocular type character display device including one image display device.

In Embodiment 1 or any of Changes 1 to 9 of Embodiment 1 which will be described later, the image display device 100, 200, 300, 400 is mounted in the form of the image display device [1], and concretely includes:

(α) an image forming device 111, 211;

(β) an optical system (parallel light emitting optical system) 112, 254 for converting a light emitted from the image forming device 111, 211 into parallel lights; and

(γ) a semi-transmissive (see-through type) optical device 120, 320 to which a luminous flux obtained as the parallel lights by the optical system 112, 254 is made incident, in which the luminous flux is guided, and from which the luminous flux is emitted.

The image forming device 111, 211 displays a monochromatic image.

It is noted that in Embodiment 1 or any of Changes 1 to 9 of Embodiment 1 which will be described later, a point at which a central light beam CL which has been emitted from a center of the image forming device 111, 211 and passes through an image forming device side nodal point of the optical system 112, 254 is made incident to the optical device 120, 320 is defined as an optical device central point O, an axis line which passes through the optical device central point O and is parallel with a direction of an axis line of the optical device 120, 320 is defined as an X-axis, and an axis line which passes through the optical device central point O and agrees with a normal line to the optical device 120, 320 is defined as a Y-axis. It is noted that a central point of a first deflecting section 130, 330 which will be described below is the optical device central point O.

Also, the optical device 120, 320 includes:

(I) a light guide plate 121, 321 from which an incident light is emitted after having been propagated through an inside of the light guide plate 121, 321 by total reflection;

(II) a first deflecting section 130, 330 for deflecting the light made incident to the light guide plate 121, 321 in such a way that the light made incident to the light guide plate 121, 321 is totally reflected inside the light guide plate 121, 321; and

(III) a second deflecting section 140, 340 for deflecting the light propagated by the total reflection through the inside of the light guide plate 121, 321 multiple times in order to emit the light propagated through the inside of the light guide plate 121, 321 by the total reflection from the light guide plate 121, 321.

Here, in Embodiment 1, the first deflecting section 130 and the second deflecting section 140 are each disposed inside the light guide plate 121. Also, the first deflecting section 130 reflects the light made incident to the light guide plate 121, and the second deflecting section 140 transmits and reflects the light which has been propagated through the inside of the light guide plate 121 by the total reflection multiple times. That is to say, the first deflecting section 130 functions as a reflecting mirror, and the second deflecting section 140 functions as a semi-transmissive mirror. More specifically, the first deflecting section 130 provided inside the light guide plate 121 is made of aluminum (Al), and is also composed of a light reflecting film (a sort of mirror) for reflecting the light made incident to the light guide plate 121. On the other hand, the second deflecting section 140 provided inside the light guide plate 121 is composed of a multilayer lamination structure in which the multiple dielectric lamination films are laminated one upon another. The dielectric lamination film, for example, is composed of a TiO₂ film as a high-permittivity material, and a SiO₂ film as a low-permittivity material. The multilayer lamination structure in which multiple dielectric lamination films are laminated one upon another is disclosed in JP-T-2005-521099. Although six dielectric lamination films are illustrated in FIG. 2, the present invention is by no means limited thereto. A thin section made of the same material as that Composing the light guide plate 121 is sandwiched between each adjacent two dielectric lamination films. It is noted that in the first deflecting section 130, the parallel lights made incident to the light guide plate 121 are reflected (or diffracted) in such a way that the parallel lights made incident to the light guide plate 121 are totally reflected inside the light guide plate 121. On the other hand, in the second deflecting section 140, the parallel lights which have been propagated through the inside of the light guide plate 121 by the total reflection are reflected (or diffracted) multiple times, and are emitted in the state of the parallel lights toward a pupil 41 of an eye of the observer.

For formation of the first deflecting section 130, a portion 124, of the light guide plate 121, in which the first deflecting section 130 is to be provided can be cut out, thereby providing a slope face for formation of the first deflecting section 130 in the light guide plate 121, and a light reflecting film can be vacuum-deposited on such a slope face. After that, the cut-out portion 124 of the light guide plate 121 can be bonded to the first deflecting section 130. In addition, for formation of the second deflecting section 140, a multilayer lamination structure can be made in which multiple pairs of materials each identical to the material composing the light guide plate 121 (for example, glass), and dielectric lamination films (for example, each of them can be deposited by utilizing a vacuum deposition method) are laminated one upon another. Also, a portion 125, of the light guide plate 121, in which the second deflecting section 140 is to be provided, can be cut out, thereby forming a slope face. Then, the multilayer lamination structure can be bonded to such a slope face, and polishing or the like can be carried out, thereby making up an external shape. The optical device 120 in which the first deflecting section 130 and the second deflecting section 140 are provided inside the light guide plate 121 can be obtained in the manner described above.

Here, in Embodiment 1 or any of Changes 1 to 9 of Embodiment 1 which will be described later, the light guide plate 121, 321 made of either an optical glass or a plastic material has two parallel surfaces (a first surface 122, 322 and a second 123, 323) each extending in parallel with a direction (X-axis) of the light propagation due to the total reflection caused in an inside of the light guide plate 121, 321. The first surface 122, 322 and the second surface 123, 323 face each other. Also, after parallel lights have been made incident to the light guide plate 121, 321 through the first surface 122, 322 corresponding to a light incidence surface and are propagated through the inside of the light guide plate 121, 321 by the total reflection, the parallel lights are emitted from the first surface 122, 322 corresponding to a light emission surface. However, the present invention is by no means limited thereto. Thus, the light incidence surface may be composed of the second surface 123, 323, and the light emission surface may be composed of the first surface 122, 322.

In Embodiment 1 or Change 2 of Embodiment 1 which will be described later, the image forming device 111 is constructed in the form of the image forming device [1], and has a plurality of pixels disposed in a two-dimensional matrix. Specifically, the image forming device 111 is composed of a reflective spatial light modulator 150, and a light source 153 composed of a light emitting diode for emitting a white light. Each of the entire image forming devices 111 is accommodated within a chassis 113 (indicated in FIG. 2 by a dashed line). The chassis 113 is provided with an opening portion (not shown), and the light is emitted from an optical system (such as a parallel light emission optical system or a collimate optical system) 112 through the opening portion. The reflective spatial optical modulator 150 is composed of a liquid crystal display device (LCD) 151 composed of an LCOS as a light valve, and a polarization beam splitter 152. In this case, the polarization beam splitter 152 reflects a part of the light emitted from the light source 153 to guide the part of the light thus reflected to the liquid crystal display device 151, and passes therethrough a part of the light reflected by the liquid crystal display device 151 to guide the part of the light thus reflected to the optical system 112. The liquid crystal display device 151 includes a plurality of pixels (liquid crystal cells) (for example, 640×480 pixels) disposed in the two-dimensional matrix. The polarization beam splitter 152 has the well-known constitution and construction. An unpolarized light emitted from the light source 153 impinges on the polarization beam splitter 152. A P-polarization component passes through the polarization beam splitter 152 to be emitted outside the system. On the other hand, an S-polarization component is reflected by the polarization beam splitter 152 to be made incident to the liquid crystal display device 151. Also, the S-polarization component is reflected inside the liquid crystal display device 151 to be emitted from the liquid crystal display device 151. Here, a lot of P-polarization component is contained in the light, of the light emitted from the liquid crystal device 151, emitted from the pixel which displays “white.” Also, a lot of S-polarization component is contained in the light, of the light emitted from the liquid crystal device 151, emitted from the pixel which displays “black.” Therefore, of the light which is emitted from the liquid crystal device 151 to impinge on the polarization beam splitter 152, the P-polarization component passes through the polarization beam splitter 152 to be guided to the optical system 112. On the other hand, the S-polarization component is reflected by the polarization beam splitter 152 to be returned back to the light source 153. The optical system 112, for example, is composed of a convex lens, and for the purpose of generating the parallel lights, the image forming device 111 (more specifically, the liquid crystal display device 151) is disposed in a place (position) of a focal distance in the optical system 112.

A frame 10 is composed of a front portion 11 disposed in front of the observer, two temple portions 13 pivotably mounted to both ends of the front portion 11 through hinges 12, respectively, and two modern portions (called end cells, ear muffs or ear pads as well) 14 mounted to the head portions of the temple portions 13, respectively. In addition, a nose pad (not shown) is mounted to the frame 10. That is to say, an assembly of the frame 10 and the nose pad basically has approximately the same construction as that of the normal eyeglasses. Moreover, the chassis 113 are detachably mounted to the temple portions 13 by mounting members 19, respectively. The frame 10 is made of either a metal or a plastic. It is noted that the chassis 113 may also be undetachably mounted to the temple portions 13 by the mounting member 19, respectively. In addition, for the observer who possesses the eyeglasses and wears the eyeglasses, the chassis 113 may also be detachably mounted to the temple portions of a frame of the eyeglasses which the observer possesses by the mounting members 19, respectively.

Moreover, wirings (such as a single line and a power source line) extending from the image forming device 111A and 111B, respectively, extend from the head portions of the modern portions 14 to the outside through the insides of the temple portions 13 and the modern portions 14 to be connected to the controller 18. Moreover, each of the image forming devices 111A and 111B includes a headphone 16, and a wiring 16′ for the headphone portion extending from each of the image forming devices 111A and 111B extends from the head portion of the modern portion 14 to the headphone portion 16 through the insides of the temple portion 13, and the modern portion 14. More specifically, the wirings 16′ for the headphone portions extend from the head portions of the modern portion 14 to the headphone portions 16 so as to be disposed around the back sides of the ear auricles (auditory capsules), respectively. By adopting such a construction, the elegant head mounted display device can be obtained because the observer is not given an impression such that the headphone 16 and the wirings 16′ for the headphone portions are disposed in a random fashion.

In addition, an image pickup device 17 composed of a solid-state image pickup element (not shown) composed of a CCD or a CMOS sensor, and a lens (not shown) is mounted to a central portion 11′ of the front portion 11 by using a suitable mounting member (not shown). A signal from the image pickup device 17 is sent to the image forming device 111A through a wiring (not shown) extending from the image pickup device 17.

The wirings (such as the signal line and the power source line) 15, as described above, are each connected to the controller (control circuit) 18. The character data (composed of the text data and the metadata) which is reproduced by a picture data/character data reproducing device 70 is sent to the controller 18 in a radio style. Also, processing for the character display is executed for the character data by the controller 18. The controller 18 can be configured in the form of the well-known circuit.

In the picture/character simultaneously displaying device of Embodiment 1, the character data contains therein not only the text data, but also the metadata about the characters to be displayed. Therefore, it is possible to reliably prevent the characters of the caption or the like from becoming difficult to visually recognize depending on the background of the characters. In addition, the member of the audience can reliably read the characters of the caption without moving his/her sight line so much, and the captions (for example, the captions based on the different languages) suitable for the members of the audience, respectively, can be readily, simultaneously displayed. In particular, it becomes difficult to satisfactorily observe the caption, the screen, the stage or the like unless a balance between the brightness of the screen, the stage or the like which is viewed through the semi-transmissive (see-through type) optical device, and the brightness or the color of the characters displayed by the optical devices falls within a given range. In the picture/character simultaneously displaying device of Embodiment 1, the character data contains therein the text data about the characters to be displayed. Therefore, the brightness or color of the characters to be displayed can be made to correspond to the screen, the stage or the like, and thus the characters can be satisfactorily, visually recognized.

It is noted that alternatively, the metadata about the characters to be displayed may be previously produced based on the processing executed by the computer or the like. Or, the picture data about the picture to be displayed may be previously read out by the computer or the like in a phase of the display (projection) of the picture, the picture data may be then analyzed, and the metadata may be produced in real time in accordance with the analysis results (such as the average luminance in the predetermined area of the picture with which the characters are synchronized (for example, an area of the picture becoming the background of the characters displayed or an area corresponding to the lower third part of the screen), and the average chromaticity in the predetermined area of the picture with which the characters are synchronized. In this case, as shown in FIG. 6 of a block diagram of a circuit for producing the metadata, all it takes is that the computer provided in the picture data/character data reproducing device 70 is made to function as an average luminance calculating section 72, a character luminance setting section 73, an average chromaticity calculating section 74, a character chromaticity setting section 75, and a metadata producing section 76, and the metadata is automatically produced in accordance with the picture data, and a given algorithm.

It is also possible to adopt a construction such that a distance between the picture displayed (for example, projected) by the picture display device 50, and the observer (the member of the audience) (a distance from the screen 51 to the observer), and a virtual image distance of the characters displayed by the image display device 100, 200, 300, 400 are made equal to each other. Specifically, all it takes is that the character display device in which the virtual image distance are set in accordance with a position of a seat on which the observer (the member of the audience) is seated in the theater, the show house or the like is rented out for the observer (the member of the audience). Or, all it takes is that the virtual image distance of the characters displayed by the image display device, for example, is made variable with 1 m increments in between, with 2 m increments in between or the like, and the virtual image distance is adjusted in accordance with the position of the seat on which the observer (the member of the audience) is seated. Or, it is also possible to adopt a system such that a distance from the position of the seat on which the observer (the member of the audience) is seated to the screen 52 is measured by using the image pickup device 17 provided in the character display device of the picture/character simultaneously displaying device, and the virtual image distance of the characters displayed by the image display device is controlled in accordance with the measurement results.

### Change 1

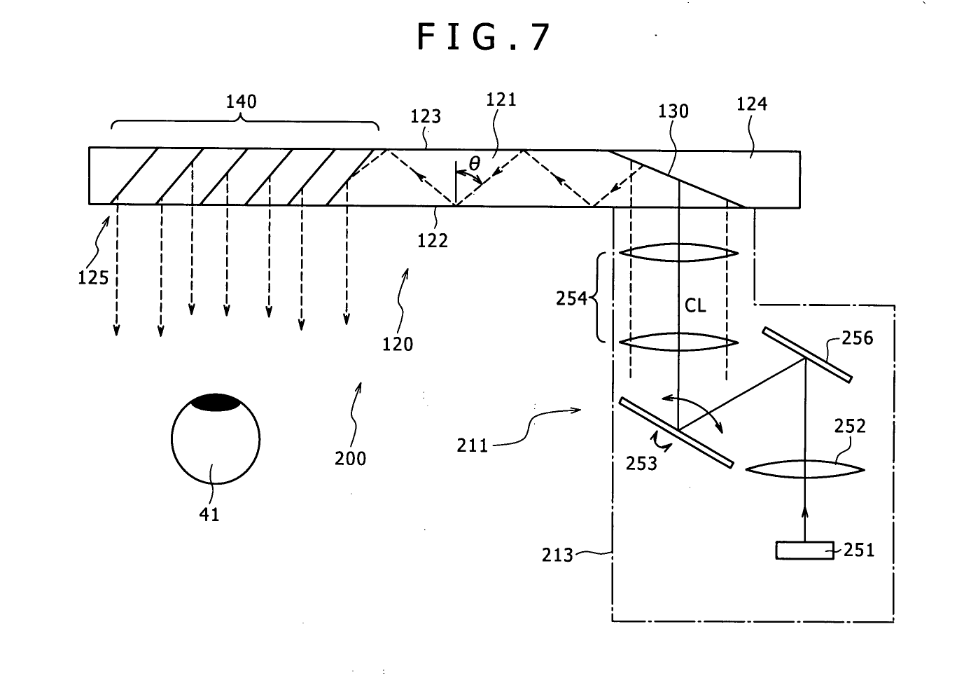

Change 1 is a change of the image display device in the character display device composing the picture/character simultaneously displaying device of Embodiment 1. As shown in FIG. 7 of a conceptual diagram of an image display device 200 in the character display device composing the picture/character simultaneously displaying device of Change 1, in Change 1, the image forming device 211 is constructed in the form of the image forming device [2]. That is to say, the image forming device 211 includes a light source 251, and a scanning section 253 for scanning parallel lights into which a light emitted from the light source 251 is converted. More specifically, the image forming device 211 is composed of:

a light source 251;

a collimate optical system 252 for converting the light emitted from the light source 251 into the parallel lights;

the scanning section 253 for scanning the parallel lights emitted from the collimate optical system 252; and

a relay optical system 254 for relaying the parallel lights scanned by the scanning section 253 to emit the parallel lights thus relayed.

It is noted that the entire image forming device 211 is accommodated within a chassis 213 (indicated in FIG. 7 by a dashed line), and the chassis 213 is provided with an opening portion (not shown), and the light is emitted from the relay optical system 254 through the opening portion. Also, the chassis 213 are detachably mounted to the temple portions 13 by the mounting members 19, respectively.

The light source 251 is composed of a light emitting element for emitting a white light. Also, the light emitted from the light source 251 is made incident to the collimate optical system 252 having a positive optical power as a whole to be emitted in the form of the parallel light. Also, the parallel lights are reflected by a totally reflecting mirror 256, and horizontal scanning and vertical scanning are carried out for the parallel lights thus reflected by the scanning section 253. In this case, the scanning section 253 is composed of an MEMS which can drive rotatably a micro-mirror in a two-dimensional direction, and can scan two-dimensionally the parallel lights made incident thereto. As a result, the parallel lights are imaged in the form of a sort of two dimensional image, thereby producing a virtual pixel (the number of pixels, for example, can be made the same as that in Embodiment 1). Also, the lights from the virtual pixels pass through the relay optical system (parallel light emission optical system) 254 composed of the well-known relay optical system, and the luminous flux made the parallel lights is then made incident to the optical device 120.

Since the optical system 120 to which the luminous flux made the parallel lights in the relay optical system 254 is made incident, in which the luminous flux is guided, and from which the luminous flux is emitted has the same constitution and construction as those of the optical device 120 described in Embodiment 1, a detailed description thereof is omitted here for the sake of simplicity of the description. In addition, since the picture/character simultaneously displaying device of Change 1 has the same constitution and construction as those of the picture/character simultaneously displaying device of Embodiment 1 except for the above difference, a detailed description thereof is omitted here for the sake of simplicity.

### Change 2

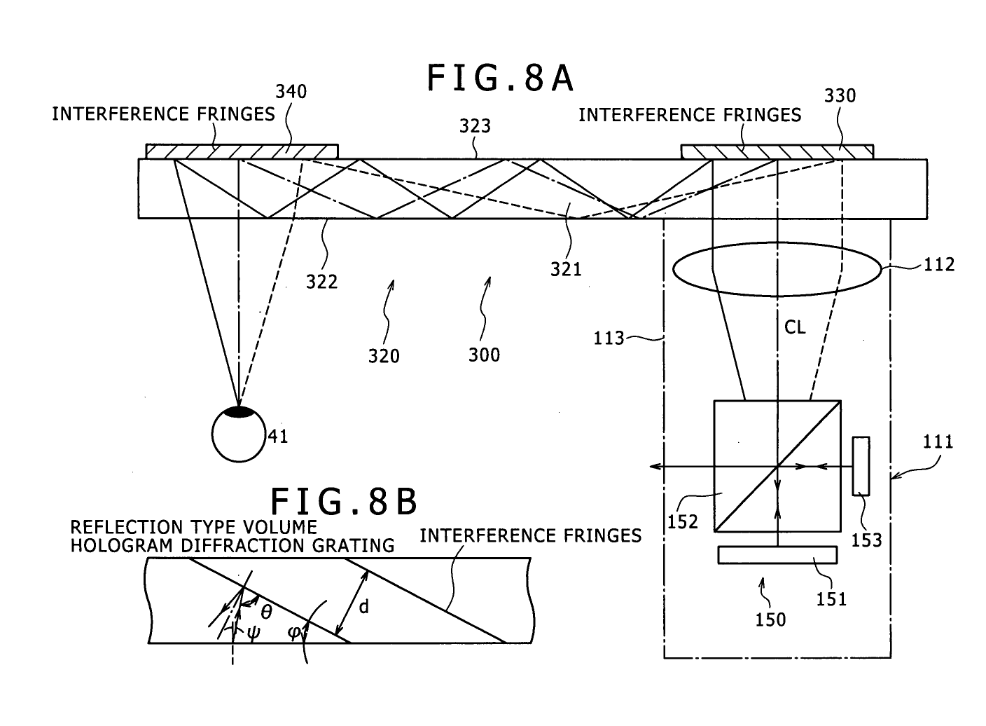

Change 2 is also a change of the image display device in the character display device composing the picture/character simultaneously displaying device of Embodiment 1. FIG. 8A shows a conceptual diagram of an image display device 300 in a character display device composing a picture/character simultaneously displaying device of Change 2. Also, FIG. 8B shows a partially enlarged schematic cross sectional view of a reflective volume hologram diffraction grating. In Change 2, the image forming device 111 is constructed in the form of the image forming device [1] similarly to the case of Embodiment 1. In addition, an optical device 320 has the same basic constitution and construction as those of the optical device 120 of Embodiment 1 except that a first deflecting section and a second deflecting section are different in constitution and construction from the first deflecting section 130 and the second diffracting section 140 of the optical device 120 in Embodiment 1.

In Change 2, each of the first deflecting section and the second deflecting section is disposed on a surface of a light guide plate 321 (specifically, a second surface 323 of the light guide plate 321). Also, the first deflecting section diffracts a light made incident to the light guide plate 321, and the second deflecting section diffracts the light multiple times which has been propagated through the inside of the light guide plate 321 by total reflection. Here, each of the first deflecting section and the second deflecting section is composed of a diffraction grating element, specifically, the reflective diffraction grating element, more specifically, a reflective volume hologram diffraction grating. In the following description, the first deflecting section composed of the reflective volume hologram diffraction grating is referred to as “a first diffraction grating member 330” for the sake of convenience of the description. Also, the second deflecting section composed of the reflective volume hologram diffraction grating is referred to as “a second diffraction grating member 340” for the sake of convenience of the description.

Also, in Change 2 or Change 3 which will be described later, each of the first diffraction grating member 330 and the second diffraction grating member 340 has a structure in which one diffraction grating layer is laminated. It is noted that the interference fringes corresponding to one kind of wavelength band (or wavelength) are formed in each of the diffraction grating layers each made of the photopolymer material, and each of the diffraction grating layers is formed by utilizing the existing method. A pitch of the interference fringes formed in the diffraction grating layer (diffraction optical element) is constant, and the interference fringes are formed linearly in parallel with a Z-axis. It is noted that an axis line of each of the first diffraction grating member 330 and the second diffraction grating member 340 is parallel with an X-axis, and a normal line is parallel with a Y-axis.

FIG. 8B shows a partially enlarged schematic cross sectional view of the reflective volume hologram diffraction grating. The interference fringes having an inclined angle Φ are formed in the reflective volume hologram diffraction grating. Here, the inclined angle Φ points to an angle between a surface of the reflective volume hologram diffraction grating, and each of the interference fringes. The interference fringes are formed from the inside to the surface of the reflective volume hologram diffraction grating. The interference fringes meet the Bragg condition. Here, the Bragg condition points to the condition fulfilling Expression (A):

m×λ=2×d×sin(Θ) (A)

where m is a positive integral number, λ is a wavelength, d is a pitch of a grating surface (a pitch in a normal line direction to a virtual plane containing therein the interference fringes), Θ is the complementary angle of an angle at which the light is made incident to the interference fringes. In addition, a relationship among the complementary angle Θ, the inclined angle Φ and an incidence angle Ψ when the light invades the diffraction grating number at the incidence angle Ψ is expressed by Expression (B):

Θ=90°−(Φ+Ψ) (B)

The first diffraction grating member 330, as described above, is disposed on (bonded to) the second surface 323 of the light guide plate 321. Thus, the first diffraction grating member 330 diffracts and reflects the parallel lights made incident to the light guide plate 321 in such a way that the parallel lights made incident from the first surface 322 to the light guide plate 321 are totally reflected inside the light guide plate 321. In addition, the second diffraction grating member 340, as described above, is disposed on (bonded to) the second surface 323 of the light guide plate 321. Thus, the second diffraction grating member 340 diffracts and reflects the parallel lights multiple times which have been propagated through the inside of the light guide plate 321 by the total reflection to emit the parallel lights as they are from the first surface 322 of the light guide plate 321.

Also, even in the light guide plate 321, after the parallel lights are propagated through the inside of the light guide plate 321 by the total reflection, the parallel lights are emitted from the first surface 322 of the light guide plate 321. At this time, since the light guide plate 321 is thin and thus an optical path along which the parallel lights progresses through the inside of the light guide plate 321 is long, the number of times of the total reflection until the parallel lights reach the second diffraction grating member 340 differs depending on field angles. More specifically, the number of times of the reflection of the parallel lights, of the parallel lights made incident to the light guide plate 321, which are made incident to the light guide plate 321 at an angle of a direction of approaching the second diffraction grating member 340 is less than the number of times of the reflection of the parallel lights made incident to the light guide plate 321 at an angle of a direction of getting away from the second diffraction grating member 340. The reason for this is because an angle between the light being propagated through the inside of the light guide plate 321, and the normal line to the light guide plate 321 when that light impinges on an inner surface of the light guide plate 321 is smaller in the parallel lights which are diffracted and reflected in the first diffraction grating member 330, and which are made incident to the light guide plate 321 at the angle of the direction of approaching the second diffraction grating member 340 than in the parallel lights made incident to the light guide plate 321 at an angle of the opposite direction. In addition, the shape of the interference fringes formed inside the second diffraction grating member 340, and the shape of the interference fringes formed inside the first diffraction grating member 330 are symmetrical with respect to a virtual surface vertical to the axis line of the light guide plate 321.

The light guide plate 321 in Change 3 which will be described later also basically has the same constitution and construction as those of the light guide plate 321 which has been described so far. Since the picture/character simultaneously displaying device of Change 2 has the same constitution and construction as those of the picture/character simultaneously displaying device of Embodiment 1, a detailed description thereof is omitted here for the sake of simplicity.

### Change 3

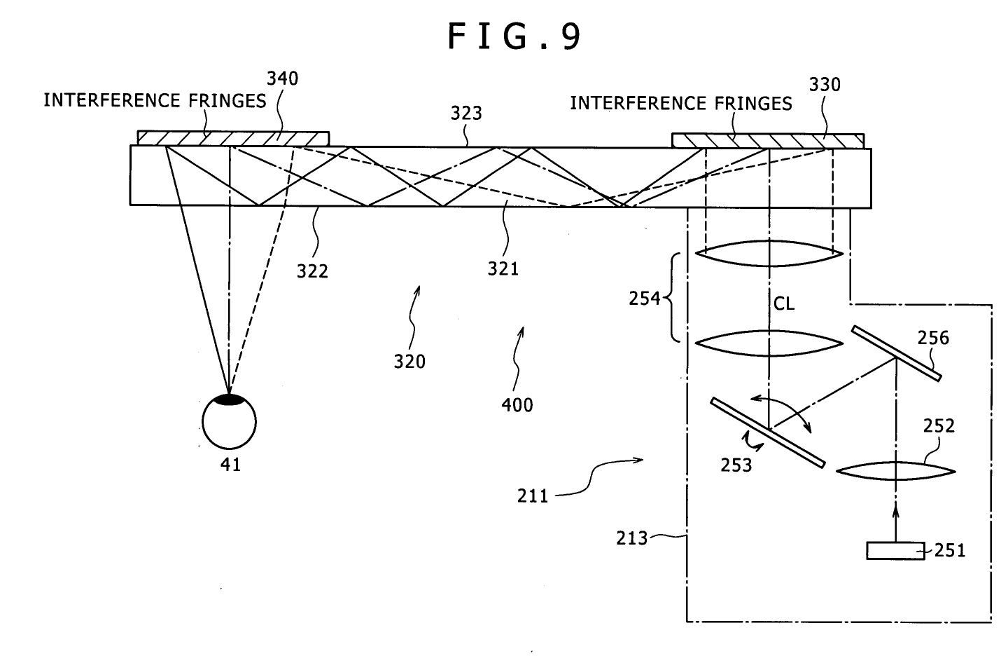

Change 3 is a change of the image display device in the character display device composing the picture/character simultaneously displaying device of Embodiment 1. FIG. 9 is a conceptual diagram of an image display device in a character display device composing a picture/character simultaneously displaying device of Change 3. The light source 251, the collimate optical system 252, the scanning section 253, the parallel light emission optical system (the relay optical system 254), and the like in an image display device 400 of Change 3 have the same constitutions and constructions as those (the image forming device [2]) of Change 1. In addition, the optical device 320 in Change 3 has the same constitution and construction as those of the optical device 320 in Change 2. Since the picture/character simultaneously displaying device of Change 3 has the same constitution and construction as those of the picture/character simultaneously displaying device of Embodiment 1, a detailed description thereof is omitted here for the sake of simplicity.

### Change 4

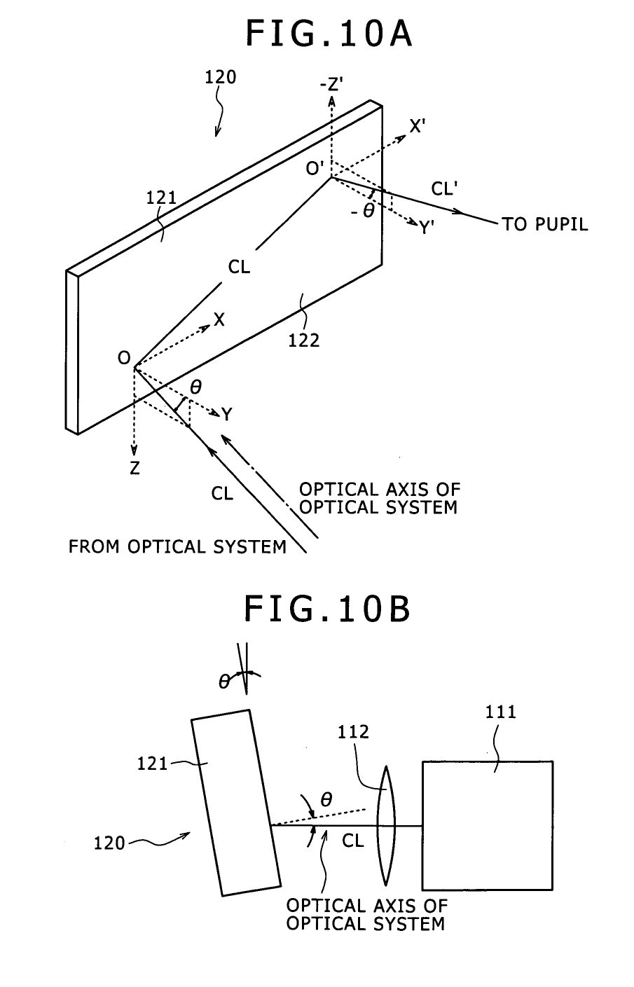

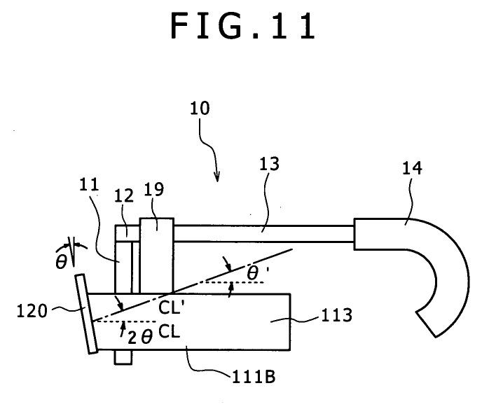

Change 4 is also a change in the character display device composing the picture/character simultaneously displaying device of Embodiment 1. FIGS. 10A and 10B are respectively a perspective view schematically showing the propagation of the light in the light guide plate composing an image display device in a picture/character simultaneously displaying device of Change 4, and a conceptual diagram showing a disposition state of the light guide plate and the like. Also, FIG. 11 is a schematic view of a head mounted display device when the head mounted display device composing a character display device in Change 4 is laterally viewed.

As shown in FIG. 3, each of Embodiment 1 and Changes 1 to 3 is designed in such a way that in the image display device 100, 300, the central light beam CL which has been emitted from the center of the image forming device 111, 211 to pass through the image forming device side nodal point of the optical system 112, 254 vertically impinges on the light guide plates 121, 321. That is to say, the central light beam CL is made incident to the light guide plates 121, 321 at an incidence angle of 0°. Also, in this case, the center of the image displayed agrees with a perpendicular line direction of each of the first surface 122, 322 of the light guide plate 121, 321.

That is to say, in the image display device typified by the image display device 100, after as shown in FIG. 3, the central light beam CL which has been emitted from the center, of the forming device 111, lying on the optical axis of the collimate optical system 112 is converted into the approximately parallel lights by the collimate optical system 112, the resulting parallel lights are made incident vertically to the first surface (plane of incidence) 122 of the light guide plate 121. Also, the parallel lights are propagated along the propagation direction A while the parallel lights are totally reflected between the first surface 122 and the second surface 123 by the first deflecting section 130. Subsequently, the central light beam CL is reflected and diffracted by the second deflecting section 140 to be emitted vertically from the first surface 122 of the light guide plate 121, thereby reaching the pupil 41 of the eye of the observer (the member of the audience).

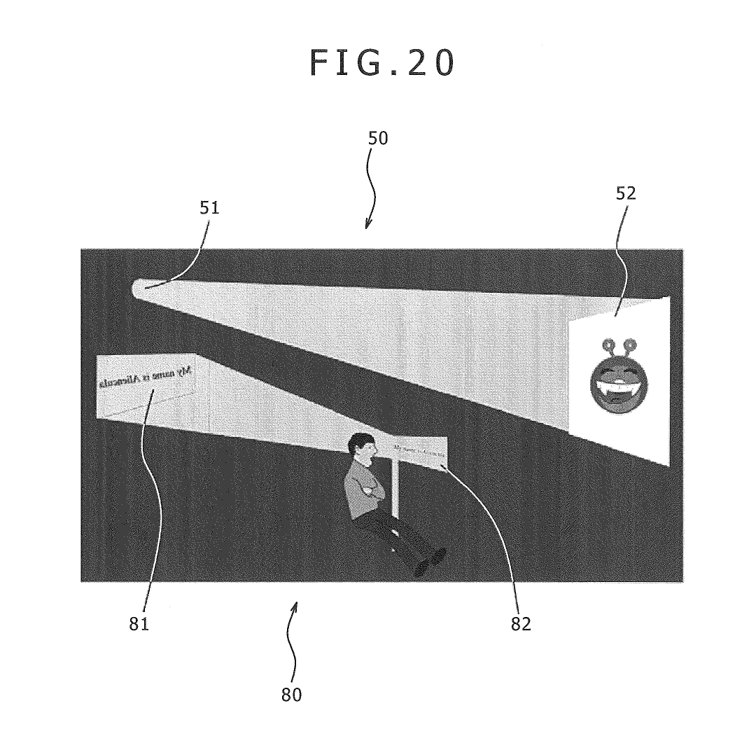

For the purpose of preventing the optical device 120, 320 from lying in the way when the observer (the member of the audience) views an object which is horizontally located in the see-through type head mounted display device, the optical device 120, 320 needs to be disposed so as to be shifted to the lower side than the sight line of the observer in the horizontal direction (the horizontal sight line of the observer). In such a case, the entire image display device 100, 300 is disposed on the lower side of the horizontal sight line of the observer. Now, with such a construction, as shown in FIG. 20, the entire image display device 100 needs to be inclined by an angle “θ.” Thus, from a relationship with the mounting portion (temple portion) of the eyeglass type frame adopted to be mounted to the head of the observer, the angle “θ” by which the image display device 100 can be inclined is limited, and the degree of freedom of the design is reduced in some cases. For this reason, it is more preferable that the optical device can be disposed with the high degree of freedom so as not to lie in the way of the horizontal sight line of the observer, and the image display device having the high degree of freedom of the design is obtained.

Change 4 adopts a constitution such that the central light beam CL intersects at an angle θ other than 0° with the XY-plane. In addition, there is adopted a construction such that the central light beam CL is contained in the YZ-plane. Moreover, in Change 4 or Change 5 which will be described later, the optical axis of the optical system 112, 254 is contained in the YZ-plane, and intersects at an angle other than 0°, specifically, at the angle θ with the XY-plane (refer to FIGS. 10A and 10B). Also, in Change 4 or Change 5 which will be described later, when the XY-plane is assumed to agree with the horizontal plane, the angle θ at which the central light beam CL intersects with the XY-plane is the angle of elevation. That is to say, the central light beam CL is directed from the lower side of the XY-plane toward the XY-plane to collide with the XY-plane. Also, the XY-plane intersects at the angle other than 0°, specifically, at the angle θ with the vertical plane.

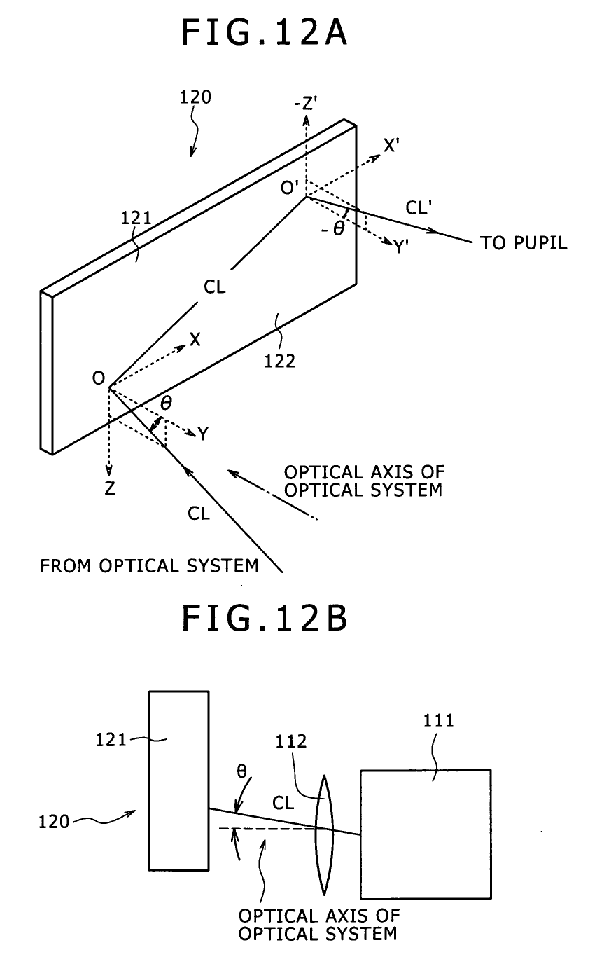

In Change 4, the angle θ is set as 5°. More specifically, with such a construction, the central light beam CL (indicated in FIG. 11 by a dashed line) is contained in the horizontal plane. Also, the optical device 120, 320 is inclined by the angle θ with respect to the vertical plane. In other words, the optical device 120, 320 is inclined by an angle of (90−θ)° with respect to the horizontal plane. In addition, a central light beam CL′ (indicated in FIG. 11 by a dashed line) emitted from the optical device 120, 320 is inclined by an angle 2θ with respect to the horizontal plane. That is to say, when the observer views the object at the infinite distance in the horizontal direction, the central light beam CL′ which has been emitted from the optical device 120, 320 to be made incident to the pupil of the eye of the observer makes an angle θ′ (=2θ) of depression with the horizontal plane (refer to FIG. 11). The angle at which the central light beam CL′ makes with the normal line to the optical device 120, 320 is θ. In FIG. 10A or FIG. 12A which will be described later, a point at which the central light beam CL′ is emitted from the optical device 120, 320 is represented by “O′,” and axis lines each of which passes through the point O′ in parallel with the X-axis, the Y-axis and the Z-axis are represented by an X′-axis, a Y′-axis and a Z′-axis, respectively.

In the image display device in Change 4, the central light beam CL intersects at the angle θ other than 0° with the XY-plane. Here, the central light beam CL′ which has been emitted from the optical device to be made incident to the pupil of the eye of the observer (the member of the audience) makes an angle θ′ of depression with the horizontal plane. The angle θ′ of depression is expressed by θ′=2θ. On the other hand, in the example shown in FIG. 20, when the same angle of depression is desired to be obtained, the entire image display device needs to be inclined by an angle θ.″ Here, a relationship between θ″ and θ is expressed by θ″=2θ. In the end, in the case of the example shown in FIG. 20, the optical device needs to be inclined by the angle 2θ with respect to the vertical plane. On the other hand, in Change 4, the optical device 120 has only to be inclined by the angle θ with respect to the vertical plane, and the image forming device has only to be horizontally held. Therefore, a limit to the mounting angle of the image display device when the image display device is mounted to the mounting portion of the eyeglass type frame is less, and thus the high degree of freedom of the design can be obtained. In addition, since the inclined angle of the optical device with respect to the vertical plane is smaller than that in the example shown in FIG. 20, such a phenomenon that an outside light is reflected by the optical device to be made incident to the pupil of the eye of the observer (the member of the audience) is difficult to occur. For this reason, an image of higher quality can be displayed.

Since the picture/character simultaneously displaying device of Change 4 has the same constitution and construction as those of the picture/character simultaneously displaying device of each of Embodiment 1 and Changes 1 to 3, a detailed description thereof is omitted here for the sake of simplicity.

### Change 5

Change 5 is also a change of the image display device in the character display device composing the picture/character simultaneously displaying device of Embodiment 1. FIGS. 12A and 12B are respectively a perspective view schematically showing the propagation of the light in the light guide plate composing an image display device in a picture/character simultaneously displaying device of Change 5, and a conceptual diagram showing a disposition state of the light guide plate and the like. Here, in Change 5, the optical axis of the optical system (such as the parallel light emission optical system or the collimate optical system) 112 is parallel with each of the YZ-plane, and the XY-plane, and passes through a position deviating from the center of the image forming device 111. By adopting such a construction, the central light beam CL is contained in the YZ-plane, and intersects at an angle θ of elevation with the XY-plane. Since a picture/character simultaneously displaying device of Change 5 has the same constitution and construction as those of the picture/character simultaneously displaying device of each of Embodiment 1 and Changes 2 to 4 except for the above point, a detailed description thereof is omitted here for the sake of simplicity.

### Change 6

Change 6 is also a change of the image display device in the character display device composing the picture/character simultaneously displaying device of Embodiment 1. FIG. 13 is a conceptual view showing a disposition state of the light guide plate and the like composing an image display device in a character display device in Change 6. In Change 6, 7, 8 or 9 which will be described later, the image display device 100, 200, 300, 400 which is described in each of Embodiment 1 and Changes 1 to 3 further includes at least a supporting member 500, 600 for pivotably supporting the image forming device 111, 211 with respect to the optical device 120, 320.

Also, in Change 6, or Changes 7 to 9 which will be described later, an assembly of at least the image forming device 111, 211 and the supporting member 500, 600 has the center CG of gravity in a position deviating from a pivotal movement central axis AX of the supporting member 500, 600. Thus, at least the image forming devices 111, 211 is pivoted with respect to the optical device 120, 300 by the gravity, thereby horizontally holding the image forming device 111, 211. It is noted that in FIGS. 13 and 14, and FIGS. 16 and 17, the pivotal movement central axis AX of the supporting member 500, 600 is indicated by a dotted line, and the axis line which passes through the center CG of gravity in parallel with the pivotal movement central axis AX is indicated by a dashed line.

In Change 6, the supporting member 500 pivotably supports the image forming device 111, 211 with respect to each of the optical device 120, 320 and the optical system 112, 254. Also, the supporting member 500 includes a first cylindrical member 501, a second cylindrical member 502, and a pivoting member 503. In this case, the pivoting member 503 is disposed between the first cylindrical member 501 and the second cylindrical member 502, and relatively pivots the first cylindrical member 501 and the second cylindrical member 502. In addition, the image forming device 111, 211 is disposed within the first cylindrical member 501, and the optical system 112, 254 is disposed within the second cylindrical member 502. Also, the optical device 120, 320 is mounted to the second cylindrical member 502.

Each of the first cylindrical member 501 and the second cylindrical member 502, for example, is made of either a plastic or a metal. The sizes (the diameters and the lengths) of the first cylindrical member 501 and the second cylindrical member 502 can be suitably determined in consideration of the sizes and the like of the entire image forming device 111, 211, the entire optical system 112, 254, the entire optical device 120, 320, and the entire character display device. The first cylindrical member 501 and the second cylindrical member 502 are disposed so as to be nested inside one another through the pivoting member 503 composed of a ball bearing.

With regard to the disposition of the image forming device 111, 211 within the first cylindrical member 501, the image forming device 111, 211 can be mounted to the inner surface of the first cylindrical member 501 by using a suitable mounting section or method. Specifically, the image forming device 111, 211 is mounted to the inner surface of the first cylindrical member 501 by utilizing a method of fitting a chassis accommodating therein the image forming device 111, 211 to the inner surface of the first cylindrical member 501. In addition, with regard to the disposition of the optical system 112, 254 within the second cylindrical member 502, the optical system 112, 254 can be mounted to the inner surface of the second cylindrical member 502 by using a suitable mounting section or method. Specifically, the optical system 112, 254 is mounted to the inner surface of the second cylindrical member 502 by utilizing a method of fitting a chassis accommodating therein the optical system 112, 254 to the inner surface of the second cylindrical member 502. The supporting member 500, more specifically, the second cylindrical member 502 is mounted to the frame 10. Specifically, the supporting member 500, more specifically, the second cylindrical member 502 is fixed to the frame 10 (more specifically, the temple portion 13). It is noted that the second cylindrical member 502 may be detachably mounted to the temple portion 13. There is no relative motion between the optical device 120, 320 and the frame 10. That is to say, the optical device 120, 320 is placed stationarily with respect to the frame 10.

In Change 6, or Changes 7 to 9 which will be described later, the assembly of at least the image forming device 111, 211 and the supporting member 500, 600 has the center CG of gravity in the position deviating (biasing) from the pivotal movement central axis AX of the supporting member 500, 600. Specifically, the image forming device 111, 211 and the like are supported by the supporting member 500, 600 in such a way that the center CG of gravity of the assembly is not located on the pivotal movement central axis AX of the supporting member 500, 600. Specifically, for example, the light source 153, 251 is disposed on the lower side, whereby the center CG of gravity of the image forming device 111, 211 can be located away from the pivotal movement central axis AX of the supporting member 500, 600.

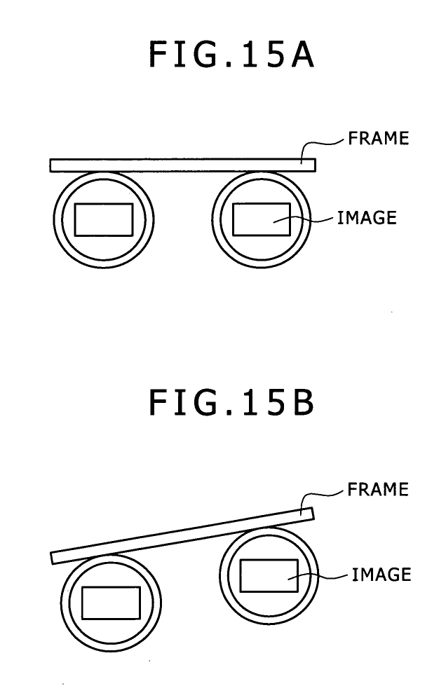

In the image display device in Change 6, the assembly of the image forming device 111 and the supporting member 500 has the center CG of gravity in a position deviating from a pivotal movement central axis AX of the supporting member 500. Thus, the image forming devices 111 is pivoted with respect to the optical device 120 by the gravity, thereby horizontally holding the image forming device 111. Therefore, with the simple constitution and construction, even when the head of the observer to which the head mounted display type character display device is mounted is inclined, the observer can observe the characters (image) horizontally held. FIGS. 15A and 15B are respectively views schematically showing a situation in which the head of the observer to which the head mounted display type character display device is mounted is inclined, the observer can observe the characters (image) horizontally held. In addition, an increase in weight, an increase in manufacture cost, and an increase in power consumption are all not caused. In addition, it is unnecessary to rotate the displayed image by executing the image processing. The image forming device having a large display area is unnecessary. Also, it is unnecessary to increase the resolution of the image forming device.

Since the picture/character simultaneously displaying device of Change 6 has the same constitution and construction as those of the picture/character simultaneously displaying device of each of Embodiment 1 and Changes 1 to 5 except for the above difference, a detailed description thereof is omitted here for the sake of simplicity.

### Change 7

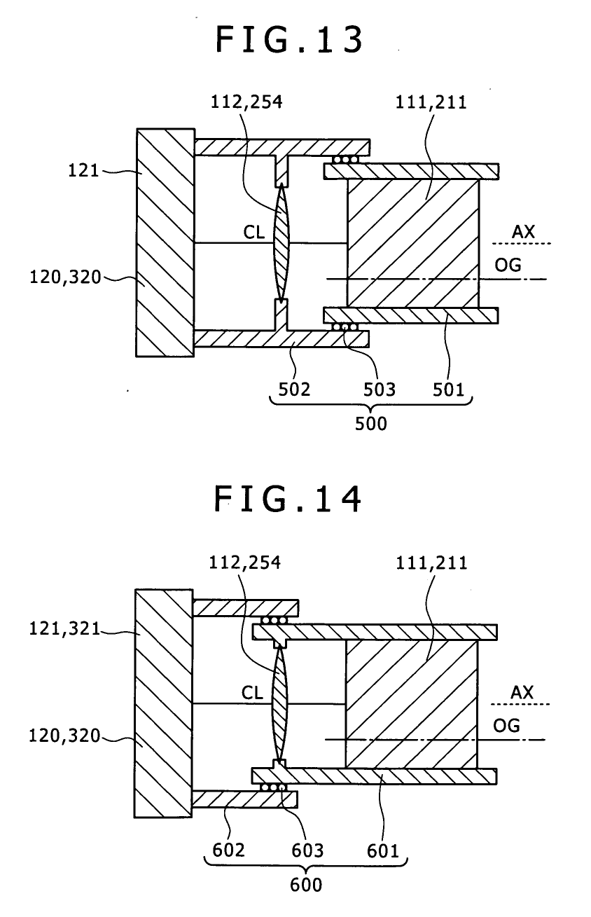

Change 7 is also a change of the image display device in the character display device composing the picture/character simultaneously displaying device of Embodiment 1. Change 6 adopts a construction that the supporting member 500 pivotably supports the image forming device 111, 211 with respect to each of the optical device 120, 320 and the optical system 112, 254. On the other hand, in Change 7, as shown in FIG. 14 of a conceptual view showing the disposition state of the light guide plate and the like, the supporting member 600 pivotably supports each of the image forming device 111, 211 and the optical system 112, 254 with respect to the optical device 120, 320. Also, the supporting member 600 includes a first cylindrical member 601, a second cylindrical member 602, and a pivoting member 603. In this case, the pivoting member 603 is disposed between the first cylindrical member 601 and the second cylindrical member 602, and relatively pivots the first cylindrical member 501 and the second cylindrical member 502. In addition, the image forming device 111, 211, and the optical system 112, 254 are disposed within the first cylindrical member 601, and the optical device 120, 320 is disposed within the second cylindrical member 602.

It is noted that with regard to the disposition of the image forming device 111, 211 and the optical system 112, 254 within the first cylindrical member 601, the image forming device 111, 211 and the optical system 112, 254 can be mounted to the inner surface of the first cylindrical member 601 by using a suitable mounting section or method. Specifically, the image forming device 111, 211 and the optical system 112, 254 are mounted to the inner surface of the first cylindrical member 601 by utilizing a method of fitting the chassis accommodating therein all the image forming device 111, 211 and the optical system 112, 254 to the inner surface of the first cylindrical member 601. In addition, with regard to the mounting of the second cylindrical member 602 to the optical device 120, 320, specifically, the second cylindrical member 602 can be mounted to the optical device 120, 320 by using a suitable mounting section or method. The supporting member 600, more specifically, the second cylindrical member 602 is mounted to the frame 10. In this case, a suitable section or method can be utilized for such mounting. Thus, the supporting member 600, more specifically, the second cylindrical member 602 is fixed to the frame (more specifically, the temple portion 13). In this case, however, the second cylindrical member 602 may also be detachably mounted to the frame 10 (more specifically, the temple portion 13).

Since the image display device in the picture/character simultaneously displaying device of Change 7 can be made to have the same constitution and construction as those of the image display device in the picture/character simultaneously displaying device of Change 6 except for the above point, a detailed description thereof is omitted here for the sake of simplicity. In addition, since the picture/character simultaneously displaying device of Change 7 has the same constitution and construction as those of the image display device in the picture/character simultaneously displaying device of each of Embodiment 1 and Changes 1 to 5, a detailed description thereof is omitted here for the sake of simplicity.

### Changes 8 and 9

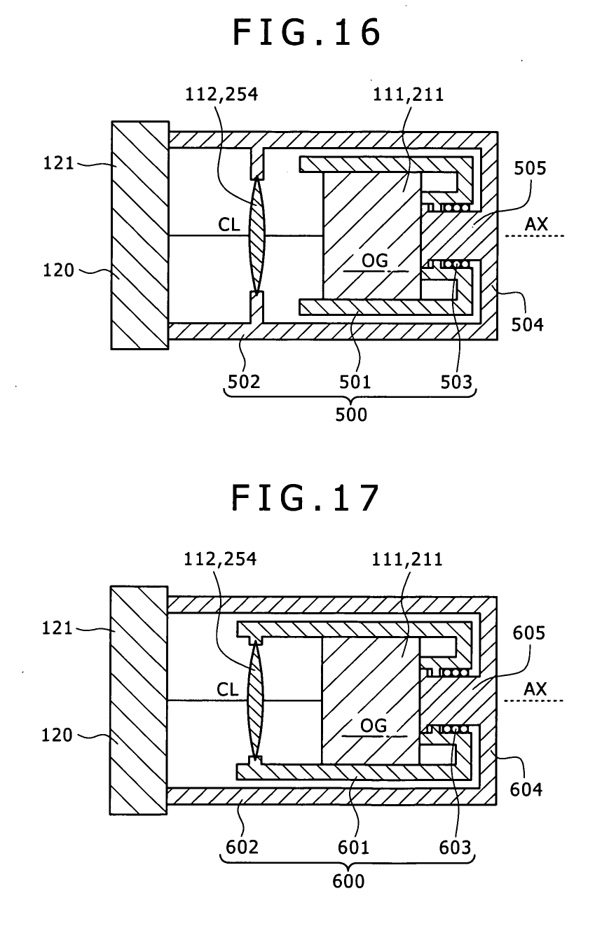

It is noted that the constructions of the first cylindrical members and the second cylindrical members in the supporting members described in Changes 6 and 7 can be modified as shown in FIGS. 16 and 17, respectively. That is to say, it is possible to adopt a construction such that a bottom plate 504, 604 is provided in a portion of the second cylindrical member 502, 602 facing the observer, a protrusion portion 505, 605 is provided from a central portion of the bottom plate 504, 604 to the inside, and the first cylindrical member 501, 601 pivots around the protrusion portion 505, 605 through the pivoting member 503, 603. In addition, when two members composing the supporting member can mutually pivot, each of the shapes of the two members may not be cylindrical.

### Change 10

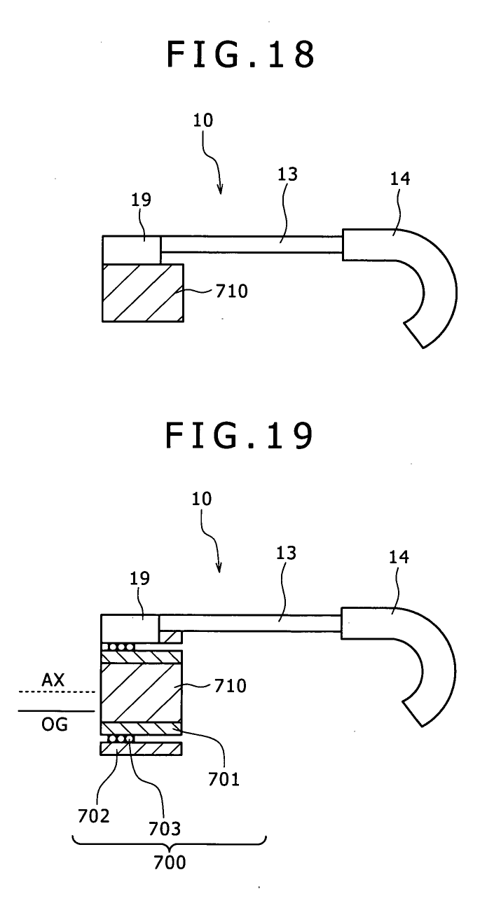

Change 10 is also a change of the image display device in the character display device composing the picture/character simultaneously displaying device of Embodiment 1. In each of Embodiment 1 and Changes 1 to 9, the image display device is constructed in the form of the image display device [1]. On the other hand, in Change 10, the image display device composing the character display device is constructed in the form of the image display device [2]. FIG. 18 shows a schematic view when the head mounted display type character display device is laterally viewed. In Change 10, the image display device 710 is constructed in the form of an image display device composed of a transmissive spatial light modulator for displaying a monochromatic (white) image, and a light source, specifically, a transmissive liquid crystal display device. It is noted that the number of pixels is set as the same as that in Embodiment 1. Also, the image display device 710 is fixedly or detachably mounted either to the front portion 11 or to the temple portion 13 by using a suitable mounting section or method. It is noted that although Change 10 includes the two image display devices 710 (binocular type), Change 10 may also include the image display device 710 (monocular type).

Since the picture/character simultaneously displaying device of Change 10 can be made to have the same constitution and construction as those of the picture/character simultaneously displaying device of Embodiment 1, a detailed description thereof is omitted here for the sake of simplicity.

### Change 11

Change 11 is also a change of the image display device in the character display device composing the picture/character simultaneously displaying device of Embodiment 1. Similarly to each of Changes 6 to 9, Change 11 includes a mechanism with which even when the head of the observer to which the head mounted display type character display device is mounted is inclined, the observer can observe the characters (image) horizontally held. FIG. 19 shows a schematic view when the head mounted display type character display device in Change 11 is laterally viewed. Specifically, the image display device 710 is pivotably mounted to the frame 10 by a supporting member 700. Also, an assembly of the image display device 710 and the supporting member 700 has the center CG of gravity in a position deviating from the pivotal movement central axis AX of the supporting member 700, and pivots the image display device 710 with respect to the frame 10 by the gravity, thereby horizontally holding the image display device 710.

In the character display device of Change 11, the image display device 710 has the center CG of gravity in the position deviating (biasing) from the pivotal movement central axis AX of the supporting member 700. Specifically, however, the image display device 710 is supported by the supporting member 700 in such a way that the center CG of gravity of the image display device 710 is not located on the pivotal movement central axis AX of the supporting member 700.

In Change 11 as well, the supporting member 700 is composed of a first cylindrical member 701 and a second cylindrical member 702 each, for example, made of either a plastic or a metal. It is noted that the sizes (diameters and lengths) of the first cylindrical member 701 and the second cylindrical member 702 can be suitably determined in consideration of the sizes and the like of the entire image display device 710 and the entire character display device. A pivoting member 703 similar to the case of Change 6 is disposed between the first cylindrical member 701 and the second cylindrical member 702, and thus the first cylindrical member 701 and the second cylindrical member 702 can be relatively pivoted. The first cylindrical member 701 and the second cylindrical member 702 are disposed so as to be nested inside one another through the pivoting member 703. The image display device 710 can be disposed within the first cylindrical member 701. With regard to the disposition of the image display device 710 within the first cylindrical member 701, the image display device 710 can be mounted to the inner surface of the first cylindrical member 701 by using a suitable mounting section or method. Specifically, the image display device 710 is mounted to the inner surface of the first cylindrical member 701 by utilizing a method of fitting a chassis accommodating therein the image display device 710 to the inner surface of the first cylindrical member 701. In addition, the image display device 710 is pivotably mounted to the frame 10 with respect to the frame 10 by the supporting member 700. Specifically, however, the second cylindrical member 702 can be mounted to the frame 10, and more specifically, the second cylindrical member 702 can be fixedly or detachably mounted to the rim portion, the front portion 11 or the temple portion 13 by using a suitable mounting section or method.

In the character display device in Change 11, the assembly of the image display device 710 and the supporting member 700 has the center CG of gravity in a position deviating from a pivotal movement central axis AX of the supporting member 700. Thus, the image display devices 710 is pivoted with respect to the frame 10 by the gravity, thereby horizontally holding the image display device 710. Therefore, with the simple constitution and construction, even when the head of the observer to which the head mounted display type character display device is mounted is inclined, the observer can observe the characters (image) horizontally held. In addition, an increase in weight, an increase in manufacture cost, and an increase in power consumption are all not caused. In addition, it is unnecessary to rotate the displayed image by executing the image processing. The image forming device having a large display area is unnecessary. Also, it is unnecessary to increase the resolution of the image forming device.

### Change 12

Change 12 is also a change of the picture/character simultaneously displaying device of Embodiment 1. A picture/character simultaneously displaying device of Change 12, as shown in FIG. 20 of a conceptual view is a projection type character display device. The character display device 80 includes a character projector 81 and a character display section 82. In this case, the character projector 81 projects the characters based on the character data, and the character display section 82 displays the characters projected by the character projector 81. The character projector 81, for example, is composed of a projector or an LED caption indicator. In addition, the character display section 82 is composed of a semi-transparent plastic plate (such as a half-mirror member made of an acrylic resin). There is adopted a form such that the character display section 82 is allocated to each and everyone of the observer (the member of the audience). Specifically, the character display section 82 can be mounted to a hand rail or the like of the seat by utilizing a suitable method.

### Change 13

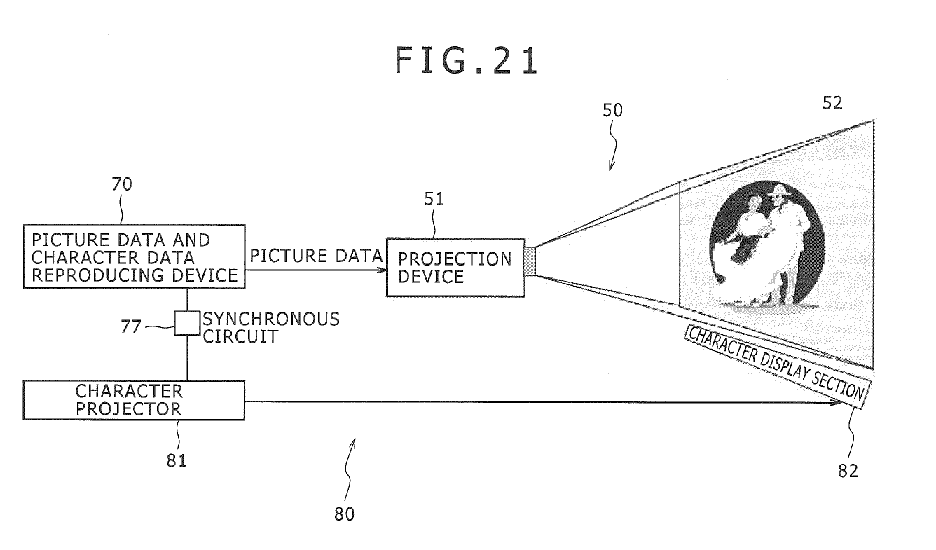

Alternatively, as shown in FIG. 21 as a conceptual view, the character display section 82 can also be constructed as a part of a screen 52. As a result, a plurality of observers (the members of the audience) can simultaneously view the characters.

It is noted that picture data composed of digital data reproduced by a picture data and character data reproducing device (a picture data/character data reproducing device 70) is sent to a projection device 51, and a picture is projected based on the picture data from the projection device 51 to be displayed on the screen 52. On the other hand, character data (composed of text data and metadata similarly to the case of Embodiment 1) reproduced by the picture data/character data reproducing device 70 is sent to a character projector 81 through a well-known synchronous circuit 77 and is processed by the character projector 81. Also, characters projected by the character projector 81 are displayed by the character display section 82.

### Embodiment 2

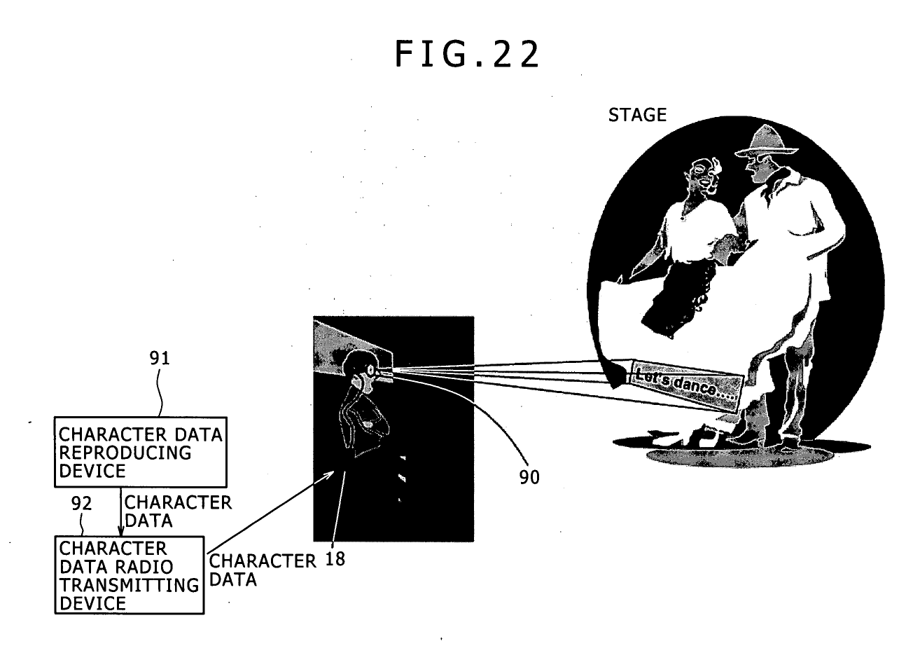

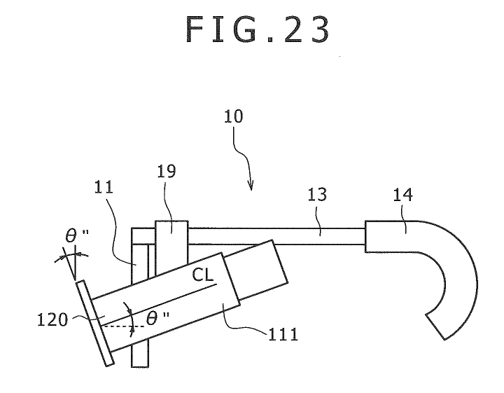

Embodiment 2 relates to the head mounted display device of the present invention. FIG. 22 shows a conceptual view in a state in which the head mounted display device according to Embodiment 2 of the present invention is used. The head mounted display device 90 of Embodiment 2 includes:

(A) the glass type frame 10 mounted to the head of the observer (the member of the audience) and;

(B) the image display device 100, 200, 300, 400, 710 mounted to the eyeglass type frame 10 for displaying the characters based on the character data.

Here, the head mounted display device 90 of Embodiment 2 has the same constitution and construction as those of the head mounted display device 90 of each of the head mounted display type character display devices composing the picture/character simultaneously displaying devices which are described in Embodiment 1 and Changes 1 to 11, respectively. Therefore, a concrete description of the head mounted display device 90 of Embodiment 2 is omitted here for the sake of simplicity.

Also, in the head mounted display device 90 Embodiment 2, the character data contains therein:

(i) the text data about the characters relating to the object which is viewed through the image display device 100, 200, 300, 400, 710; and

(ii) the metadata about the characters to be displayed.

In the head mounted display device 90 of Embodiment 2, the metadata is composed of the luminance data and the chromaticity data similarly to the case of Embodiment 1. Also, the luminance data composing the metadata is luminance data corresponding to a luminance of a predetermined area (for example, an area corresponding to the lower third part of the entire stage) containing therein an object (such as a character and a background) which is viewed through the image display device. Also, the chromaticity data composing the metadata is chromaticity data corresponding to a chromaticity of the predetermined area containing therein the object which is viewed through the image display device. In addition, in the head mounted display device 90 as well of Embodiment 2, similarly to the case of Embodiment 1, the character data is reproduced by the character data reproducing device 91, and is then sent to the image display device composing the head mounted display device 90 in a radio style through the character data radio transmitting device 92.

In the head mounted display device 90 as well of Embodiment 2, the text data is the digitized data which is used in order to display the characters relating to the object which is viewed through the image display device 100, 200, 300, 400, 710 by the image display device 100, 200, 300, 400, 710, and thus is previously produced. The metadata about the characters to be displayed, for example, is also previously produced. However, there may be adopted such a process that the image of the target (object) such as various devices, person and article is captured by using the image pickup device 17, the image-captured contents are analyzed by the controller 18 of the image display device 100, 200, 300, 400, 710, and the metadata is produced in real time by the image display device 100, 200, 300, 400, 710 in accordance with the analysis results (the luminance data corresponding to the luminance of the predetermined area containing therein the target viewed through the image display device 100, 200, 300, 400, 710, and the chromaticity data).

In addition, in the head mounted display device 90 as well of Embodiment 2, it is also possible to adopt a construction such that the distance between the target and the observer (the member of the audience), and the virtual image distance of the characters displayed by the image display device can be made equal to each other.

In use of the head mounted display device 90 of Embodiment 2, for example, in viewing a play, the characters relating to the target (such as the description about the situation and the background of the play, the description about the characters, and the conversation of the characters) relating to the target can be displayed at a suitable timing by the image display device 100, 200, 300, 400, 710. Specifically, for example, the character data can be sent to the image display device 100, 200, 300, 400, 710 either in accordance with the progress status of the play or the manipulation made by the operator, or under the control made by the computer, and the characters can be displayed by the image display device 100, 200, 300, 400, 710.

In the head mounted display device 90 as well of Embodiment 2, the character data contains therein not only the text data, but also the metadata about the characters to be displayed. Therefore, it is possible to reliably prevent the characters for the explanation or the like of the target or the like which the observer (the member of the audience) views from becoming difficult to visually recognize depending on the background of the characters. In addition, in viewing the play or the like, the member of the audience can reliably read the description for explaining the contents, the progress status, the background and the like of the play or the like without moving his/her sight line so much, and the descriptions (for example, the descriptions based on the different languages) suitable for the observers (the members of the audience), respectively, can be readily, simultaneously displayed. In particular, it becomes difficult to satisfactorily observe the stage or the like unless the balance between the brightness of the stage or the like which is viewed through the semi-transmissive (see-through type) optical device, and the brightness or the color of the characters displayed by the optical devices falls within a given range. In the head mounted display device of Embodiment 2, the character data contains therein the metadata about the characters to be displayed. Therefore, the brightness or color of the characters to be displayed can be made to correspond to the stage or the like, and thus the characters can be satisfactorily, visually recognized.

Although the present invention has been described so far based on the preferred embodiments, the present invention is by no means limited thereto. That is to say, the constitutions and constructions of the picture/character simultaneously displaying device, the head mounted display device, the image display device, the supporting member and the like are merely exemplified, and thus can be suitably changed. For example, a relief type hologram (refer to US Patent No. 20040062505 A1) may be disposed on the surface of the light guide plate. In the optical device 320 of Change 2 or 3, the diffraction grating element can be constructed in the form of a transmissive diffraction grating element. Or, one of the first deflecting section and the second deflecting section can also be constructed in the form of a reflective diffracting grating element, and the other can be constructed in the form of a transmissive diffracting grating element. Or, the diffracting grating element can also be constructed in the form of a reflective blazed diffracting grating element.

The present application contains subject matter related to that disclosed in Japanese Priority Patent Application JP 2009-202686 filed in the Japan Patent Office on Sep. 2, 2009, the entire content of which is hereby incorporated by reference.

What is claimed is:

1. A picture/character simultaneously displaying device, comprising:
(a) a picture display device for displaying a picture based on picture data; and
(b) a character display device for displaying characters synchronous with the picture based on character data,
wherein the character data contains therein
(i) text data about characters synchronous with a picture to be displayed, and
(ii) metadata about characters to be displayed.

2. The picture/character simultaneously displaying device according to claim 1, wherein the metadata is luminance data about the characters to be displayed, or chromaticity data about the characters to be displayed, or the luminance data and the chromaticity data.

3. The picture/character simultaneously displaying device according to claim 2, wherein the luminance data composing the metadata is luminance data corresponding to an average luminance in an entire area or a predetermined area of the picture with which the characters are synchronized.

4. The picture/character simultaneously displaying device according to claim 2, wherein the chromaticity data composing the metadata is chromaticity data corresponding to an average chromaticity in an entire area or a predetermined area of the picture with which the characters are synchronized.

5. The picture/character simultaneously displaying device according to claim 1, wherein
said character display device is composed of a head mounted display device including:
(A) an eyeglass type frame mounted to a head of an observer; and
(B) an image display device mounted to said eyeglass type frame for displaying the characters based on the character data.

6. The picture/character simultaneously displaying device according to claim 5, wherein a distance between a picture displayed by said picture display device, and said observer, and a virtual image distance of the characters displayed by said image display device are made equal to each other.

7. The picture/character simultaneously displaying device according to claim 5, wherein
said image display device includes:
(α) an image forming device;
(β) an optical system for converting a light emitted from said image forming device into parallel lights; and
(γ) a semi-transmissive optical device to which a luminous flux obtained as the parallel lights by said optical system is made incident, in which the luminous flux is guided, and from which the luminous flux is emitted.

8. The picture/character simultaneously displaying device according to claim 7, wherein
said optical device includes:
(I) a light guide plate from which an incident light is emitted after being propagated through an inside of said light guide plate by total reflection;
(II) first deflecting means for deflecting the light made incident to said light guide plate in such a way that the light made incident to said light guide plate is totally reflected inside said light guide plate; and
(III) second deflecting means for deflecting the light propagated through the inside of said light guide plate by the total reflection multiple times in order to emit the light propagated through the inside of said light guide plate by the total reflection from said light guide plate.

9. The picture/character simultaneously displaying device according to claim 5, wherein a frame is composed of a front portion disposed in front of said observer, and two temple portions pivotably mounted to both ends of said front portion through hinges.

10. The picture/character simultaneously displaying device according to claim 1, wherein the character data is sent to said character display device in a radio style.

11. The picture/character simultaneously displaying device according to claim 1, wherein
said character display device includes
a character projector for projecting characters based on the character data, and
character display means for displaying the characters projected by said character projector.

12. A head mounted display device, comprising:
(A) a glass type frame mounted to a head portion of an observer; and
(B) an image display device mounted to said glass type frame for displaying characters based on character data,
wherein the character data contains therein
(i) text data about characters relating to an object viewed through said image display device, and
(ii) metadata about characters to be displayed.

13. The head mounted display device according to claim 12, wherein the metadata is luminance data about the characters to be displayed, or chromaticity data about the characters to be displayed, or the luminance data and the chromaticity data.

14. The head mounted display device according to claim 13, wherein the luminance data composing the metadata is luminance data corresponding to a luminance of a predetermined area containing therein said object which is viewed through said image display device.

15. The head mounted display device according to claim 13, wherein the chromaticity data composing the metadata is chromaticity data corresponding to a chromaticity of a predetermined area containing therein said object which is viewed through said image display device.

16. The head mounted display device according to claim 12, wherein a distance between said object and said observer, and a virtual image distance of the characters displayed by said image display device are made equal to each other.

17. The head mounted display device according to claim 12, wherein
said image display device includes:
(α) an image forming device;
(β) an optical system for converting a light emitted from said image forming device into parallel lights; and
(γ) a semi-transmissive optical device to which a luminous flux obtained as the parallel lights by said optical system is made incident, in which the luminous flux is guided, and from which the luminous flux is emitted.

18. The head mounted display device according to claim 17, wherein
said optical device includes:
(I) a light guide plate from which an incident light is emitted after being propagated through an inside of said light guide plate by total reflection;
(II) first deflecting means for deflecting the light made incident to said light guide plate in such a way that the light made incident to said light guide plate is totally reflected inside said light guide plate; and
(III) second deflecting means for deflecting the light propagated through the inside of said light guide plate by the total reflection multiple times in order to emit the light propagated through the inside of said light guide plate by the total reflection from said light guide plate.

19. The head mounted display device according to claim 12, wherein a frame is composed of a front portion disposed in front of said observer, and two temple portions pivotably mounted to both ends of said front portion through hinges.

20. The head mounted display device according to claim 12, wherein the character data is sent to said image display device in a radio style.
